(19) United States
(12) Patent Application Publication
(10) Pub. No.: US 2001/0009009 A1
(43) Pub. Date: Jul. 19, 2001

(54) Character string dividing or separating method and related system for segmenting agglutinative text or document into words

(75) Inventor: Yasuki Iizuka, Fujisawa-shi (JP)

Correspondence Address: PARKHURST & WENDEL, L.L.P., Suite 210, 1421 Prince Street, Alexandria, VA, 22314-2805, US

(73) Assignee: MATSUSHITA ELECTRIC INDUSTRIAL CO., LTD.

(21) Appl. No.: 09/745,795

(22) Filed: Dec. 26, 2000

(30) Foreign Application Priority Data
Jun. 30, 2000 (JP) 2000-199738
Dec. 28, 1999 (JP) 11-373272

(51) Int. Cl. G06F 15/00

(52) U.S. Cl. 707/539; 707/531

(57) ABSTRACT

A joint probability of two neighboring characters appearing in a given Japanese document database is statistically calculated. The calculated joint probabilities are stored in a table. An objective Japanese sentence is segmented into a plurality of words with reference to the calculated joint probabilities so that each division point of the objective Japanese sentence is present between two neighboring characters having a smaller joint probability.

### BACKGROUND OF THE INVENTION

The present invention relates to a character string dividing or segmenting method and related apparatus for efficiently dividing or segmenting an objective character string (e.g., a sentence, a compound word, etc.) into a plurality of words, preferably applicable to preprocessing and/or analysis for a natural language processing system which performs computerized processing of text or document data for the purpose of complete computerization of document search, translation, etc.

A word is a character string, i.e., a sequence or assembly of characters, which has a meaning by itself. In this respect, a word can be regarded as a smallest unit of characters which can express a meaning. A sentence consists of a plurality of words. In this respect, a sentence is a character string having a more large scale. A document is an assembly of a plurality of sentences.

In general, Japanese language, Chinese language, and some of Asian languages are classified into a group of agglutinative languages which do not explicitly separate characters to express a boundary of words. For a person who has no knowledge of the language, a Japanese (or Chinese) language is a long character string according to which each boundary of neighboring words is not clear. This is a characteristic difference between the agglutinative languages and non-agglutinative languages such as English or other European languages.

A natural language processing system is used in the field of computerized translation, automatic summarization or the like. To operate the natural language processing system, the inevitably required preprocessing is an analysis of each sentence. When a Japanese text (or document) is handled, dividing or segmenting a sentence into several words is an initial analysis to be done beforehand.

For example, a document search system may be used for a Japanese character string “ [symbol] [symbol] (Tokyo metropolitan assembly of this month)”, according to which a search for a word “ [symbol] ” will hit the words relating to “ [symbol] (Tokyo)” on one hand and the words relating to “ [symbol] (Kyoto)” on the other hand under the circumstances that no knowledge of the word is given. In this case, the words relating to “ [symbol] ” are not required and are handled as search noises.

As a convention word division technique applicable to agglutinative languages, the U.S. Pat. No. 6,098,035 discloses a morphological analysis method and device, according to which partial chain probabilities of N-gram character sequences are stored in character table. Division points of a sentence is determined with reference to the partial chain probabilities. For the purpose of learning, this system requires preparation of sentences (or documents) which are divided or segmented into words beforehand.

Regarding the N-gram character sequences, an article “Estimation of morphological boundary based on normalized frequency” is published by the Information Processing Society of Japan, the working group for natural language processing, NL-113-3, 1996.

As a similar prior art, the unexamined Japanese patent publication No. 10-254874 discloses a morpheme analyzer which requires a learning operation based on document data divided into words beforehand.

Furthermore, the unexamined Japanese patent publication No. 9-138801 discloses a character string extracting method and its system which utilizes the N-gram.

### SUMMARY OF THE INVENTION

An object of the present invention is to provide a character string dividing method and related apparatus for efficiently dividing or segmenting an objective character string of an agglutinative language into a plurality words.

In order to accomplish this and other related objects, the present invention provides a first character string dividing system for segmenting a character string into a plurality of words. An input section means is provided for receiving a document. A document data storing means, serving as a document database, is provided for storing a received document. A character joint probability calculating means is provided for calculating a joint probability of two neighboring characters appearing in the document database. A probability table storing means is provided for storing a table of calculated joint probabilities. A character string dividing means is provided for segmenting an objective character string into a plurality of words with reference to the table of calculated joint probabilities. And, an output means is provided for outputting a division result of the objective character string.

The present invention provides a first character string dividing method for segmenting a character string into a plurality of words. The first method comprises a step of statistically calculating a joint probability of two neighboring characters appearing in a given document database, and a step of segmenting an objective character string into a plurality of words with reference to calculated joint probabilities so that each division point of the objective character string is present between two neighboring characters having a smaller joint probability.

According to the first character string dividing method, it is preferable that the division point of the objective character string is determined based on a comparison between the joint probability and a threshold (δ), and the threshold is determined with reference to an average word length of resultant words.

According to the first character string dividing method, it is preferable that a changing point of character type is considered as a prospective division point of the objective character.

According to the first character string dividing method, it is preferable that a comma, parentheses and comparable symbols are considered as division points of the objective character.

The present invention provides a second character string dividing method for segmenting a character string into a plurality of words. The second method comprises a step of statistically calculating a joint probability of two neighboring characters (Cᵢ₋₁Cᵢ) appearing in a given document database. The joint probability P(Ci|C_{i-N+1} - - - Cᵢ₋₁) is calculated as an appearance probability of a specific character string (C_{i-N+1} - - - Cᵢ₋₁) appearing immediately before a specific character (Cᵢ). The specific character string includes a former one (Cᵢ₋₁) of the two neighboring characters as a tail thereof and the specific character is a latter one (Cᵢ) of the two neighboring characters. Furthermore, the second method comprises a step of segmenting an objective character string into a plurality of words with reference to calculated joint probabilities so that each division point of the objective character string is present between two neighboring characters having a smaller joint probability.

The present invention provides a third character string dividing method for segmenting a character string into a plurality of words. The third method comprises a step of statistically calculating a joint probability of two neighboring characters (Ci−1Ci) appearing in a given document database. The joint probability (P(Ci|Ci−n - - - Ci−1)×P(Ci−1|Ci - - - Ci+m−1)) is calculated as an appearance probability of a first character string (Ci−n - - - Ci−1) appearing immediately before a second character string (Ci - - - Ci+m−1). The first character string includes a former one (Ci−1) of the two neighboring characters as a tail thereof, and the second character string includes a latter one (Ci) of the two neighboring characters as a head thereof. Furthermore, the third method comprises a step of segmenting an objective character string into a plurality of words with reference to calculated joint probabilities so that each division point of the objective character string is present between two neighboring characters having a smaller joint probability.

According to the third character string dividing method, it is preferable that the joint probability of two neighboring characters is calculated based on a first probability (Count(Cᵢ₋ₙ - - - Cᵢ)/Count(Cᵢ₋ₙ - - - Cᵢ₋₁)) of the first character string appearing immediately before the latter one of the two neighboring characters and also based on a second probability (Count(Cᵢ₋₁ - - - Cᵢ₊ₘ₋₁)/Count(Cᵢ - - - Cᵢ₊ₘ₋₁)) of the second character string appearing immediately after the former one of the two neighboring characters.

The present invention provides a fourth character string dividing method for segmenting a character string into a plurality of words. The fourth method comprises a step of statistically calculating a joint probability of two neighboring characters appearing in a given document database prepared for learning purpose, and a step of segmenting an objective character string into a plurality of words with reference to calculated joint probabilities so that each division point of the objective character string is present between two neighboring characters having a smaller joint probability. According to the fourth method, when the objective character string involves a sequence of characters not involved in the document database, a joint probability of any two neighboring characters not appearing in the database is estimated based on the calculated joint probabilities for the neighboring characters stored in the document database.

The present invention provides a second character string dividing system for segmenting a character string into a plurality of words. An input means is provided for receiving a document. A document data storing means, serving as a document database, is provided for storing a received document. A character joint probability calculating means is provided for calculating a joint probability of two neighboring characters appearing in the document database. A probability table storing means is provided for storing a table of calculated joint probabilities. A word dictionary storing means is provided for storing a word dictionary prepared or produced beforehand. A division pattern producing means is provided for producing a plurality of candidates for a division pattern of an objective character string with reference to information of the word dictionary. A correct pattern selecting means is provided for selecting a correct division pattern from the plurality of candidates with reference to the table of character joint probabilities. And, an output means is provided for outputting the selected correct division pattern as a division result of the objective character string.

The present invention provides a fifth character string dividing method for segmenting a character string into a plurality of words. The fifth method comprises a step of statistically calculating a joint probability of two neighboring characters appearing in a given document database, a step of storing calculated joint probabilities, and a step of segmenting an objective character string into a plurality of words with reference to a word dictionary. When there are a plurality of candidates for a division pattern of the objective character string, a correct division pattern is selected from the plurality of candidates with reference to calculated joint probabilities so that each division point of the objective character string is present between two neighboring characters having a smaller joint probability.

According to the fifth character string dividing method, it is preferable that a score of each candidate is calculated when there are a plurality of candidates for a division pattern of the objective character string. The score is a sum or a product of joint probabilities at respective division points of the objective character string in accordance with a division pattern of the each candidate. And, a candidate having the smallest score is selected as the correct division pattern.

Furthermore, it is preferable that a calculated joint probability is given to each division point of the candidate. A constant value is assigned to each point between two characters not divided. A score of each candidate is calculated based on a sum or a product of the joint probability and the constant value thus assigned. And, a candidate having the smallest score is selected as the correct division pattern.

The present invention provides a third character string dividing system for segmenting a character string into a plurality of words. An input means is provided for receiving a document. A document data storing means, serving as a document database, is provided for storing a received document. A character joint probability calculating means is provided for calculating a joint probability of two neighboring characters appearing in the document database. A probability table storing means is provided for storing a table of calculated joint probabilities. A word dictionary storing means is provided for storing a word dictionary prepared or produced beforehand. An unknown word estimating means is provided for estimating unknown words not registered in the word dictionary. A division pattern producing means is provided for producing a plurality of candidates for a division pattern of an objective character string with reference to information of the word dictionary and the estimated unknown words. A correct pattern selecting means is provided for selecting a correct division pattern from the plurality of candidates with reference to the table of character joint probabilities. And, an output means is provided for outputting the selected correct division pattern as a division result of the objective character string.

The present invention provides a sixth character string dividing method for segmenting a character string into a plurality of words. The sixth method comprises a step of statistically calculating a joint probability of two neighboring characters appearing in a given document database, a step of storing calculated joint probabilities, and a step of segmenting an objective character string into a plurality of words with reference to dictionary words and estimated unknown words. When there are a plurality of candidates for a division pattern of the objective character string, a correct division pattern is selected from the plurality of candidates with reference to calculated joint probabilities so that each division point of the objective character string is present between two neighboring characters having a smaller joint probability.

According to the sixth character string dividing method, it is preferable that it is checked if any word starts from a certain character position (i) when a preceding word ends at a character position (i−1) and, when no dictionary word starting from the character position (i) is present, appropriate character strings are added as unknown words starting from the character position (i), where the character strings to be added have a character length not smaller than n and not larger than m, where n and m are positive integers.

Furthermore, it is preferable that a constant value (V) given to the unknown word is larger than a constant value (U) given to the dictionary word. A score of each candidate is calculated based on a sum or a product of the constant values given to the unknown word and the dictionary word in addition to a sum or a product of calculated joint probabilities at respective division points. And, a candidate having the smallest score is selected as the correct division pattern.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a flowchart showing a character string dividing or segmenting procedure in accordance with a first embodiment of the present invention;

FIG. 2 is a block diagram showing an arrangement of a character string dividing system in accordance with the first embodiment of the present invention;

FIG. 3 is a flowchart showing a calculation procedure of a character joint probability in accordance with the first embodiment of the present invention;

FIG. 4A is a view showing an objective character string with a specific symbol located at the head thereof in accordance with the first embodiment of the present invention;

FIG. 4B is a table showing appearance frequencies of 2-grams involved in the objective character string shown in FIG. 4A;

FIG. 4C is a table showing appearance frequencies of 3-grams involved in the objective character string shown in FIG. 4A;

FIG. 4D is a table showing calculated character joint probabilities of respective 3-grams involved in the objective character string shown in FIG. 4A;

FIG. 4E is a view showing a pointer position and a joint probability of a pointed 3-gram;

FIG. 4F is a view showing the relationship between calculated joint probabilities and corresponding 3-grams involved in the objective character string shown in FIG. 4A;

FIG. 5 is a flowchart showing a calculation procedure for a character string division process in accordance with the first embodiment of the present invention;

FIG. 6A is a view showing another objective character string with a specific symbol located at the head thereof in accordance with the first embodiment of the present invention;

FIG. 6B is a table showing appearance frequencies of 2-grams involved in the objective character string shown in FIG. 6A;

FIG. 6C is a table showing appearance frequencies of 3-grams involved in the objective character string shown in FIG. 6A;

FIG. 6D is a table showing calculated character joint probabilities of respective 3-grams involved in the objective character string shown in FIG. 6A;

FIG. 6E is a view showing the relationship between calculated joint probabilities and corresponding 3-grams involved in the objective character string shown in FIG. 6A;

FIG. 7 shows a practical example of character joint probabilities obtained from many Japanese documents involving 10 millions of Japanese characters generally used in newspapers in accordance with the first embodiment of the present invention;

FIG. 8 shows a division pattern of a given sentence obtained based on the joint probability data shown in FIG. 7;

FIG. 9 is a flowchart showing a calculation procedure of the character joint probability in the case of n≠m in accordance with a second embodiment of the present invention;

FIG. 10 is a flowchart showing a calculation procedure of the character joint probability in the case of n=m in accordance with the second embodiment of the present invention;

FIG. 11 is a flowchart showing a calculation procedure for a character string division in accordance with the second embodiment of the present invention;

FIG. 12A is a view showing an objective character string with specific symbols located at the head and the tail thereof in accordance with the second embodiment of the present invention;

FIG. 12B is a table showing appearance frequencies of 2-grams involved in the objective character string shown in FIG. 12A;

FIG. 12C is a table showing appearance frequencies of 3-grams involved in the objective character string shown in FIG. 12A;

FIG. 12D is a table showing calculated character joint probabilities of respective 3-grams involved in the objective character string shown in FIG. 12A;

FIG. 12E is a view showing a pointer position and joint probabilities of first and second factors of a pointed 3-gram;

FIG. 12F is a view showing the relationship between calculated joint probabilities and corresponding 3-grams involved in the objective character string shown in FIG. 12A;

FIG. 13 is a conceptual view showing the relationship between a threshold and an average word length in accordance with the second embodiment of the present invention;

FIG. 14 is a view showing first and second factors and corresponding character strings in accordance with the second embodiment of the present invention;

FIG. 15 is a block diagram showing an arrangement of a character string dividing system in accordance with a third embodiment of the present invention;

FIG. 16 is a flowchart showing a character string dividing or segmenting procedure in accordance with the third embodiment of the present invention;

FIG. 17A is a view showing division candidates of a given character string in accordance with the third embodiment of the present invention;

FIG. 17B is a view showing calculated character joint probabilities of the character string shown in FIG. 17A;

FIG. 18A is a view showing division candidates of another given character string in accordance with the third embodiment of the present invention;

FIG. 18B is a view showing calculated character joint probabilities of the character string shown in FIG. 18A;

FIG. 18C is a view showing calculated scores of the division candidates shown in FIG. 18A;

FIG. 19 is a flowchart showing details of selecting a correct division pattern of an objective character string from a plurality of candidates in accordance with the third embodiment of the present invention;

FIG. 20 is a view showing the relationship between a given character string and dictionary words in accordance with the third embodiment of the present invention;

FIG. 21 is a block diagram showing an arrangement of a character string dividing system in accordance with a fourth embodiment of the present invention;

FIG. 22 is a flowchart showing a character string dividing or segmenting procedure in accordance with the fourth embodiment of the present invention;

FIG. 23 is a flowchart showing details of selecting a correct division pattern of an objective character string from a plurality of candidates in accordance with the fourth embodiment of the present invention;

FIG. 24 is a view showing words registered in a word dictionary storing section in accordance with the fourth embodiment of the present invention;

FIG. 25A is a view showing the relationship between a given character string and dictionary words in accordance with the fourth embodiment of the present invention;

FIG. 25B is a view showing the relationship between the character string and dictionary words and unknown words in accordance with the fourth embodiment of the present invention;

FIG. 26 is a view showing a division process of a given character string in accordance with the fourth embodiment of the present invention;

FIG. 27 is a view showing division candidates of the character string shown in FIG. 26;

FIG. 28A is a view showing calculated scores of division candidates of a given character string in accordance with a fifth embodiment of the present invention;

FIG. 28B is a view showing calculated character joint probabilities of the character string shown in FIG. 28A; and

FIG. 28C is a view showing selection of a correct division pattern in accordance with the fifth embodiment of the present invention.

### DESCRIPTION OF THE PREFERRED EMBODIMENTS

### Principle of Character String Division

First of all, the nature of language will be explained with respect to the appearance probability of each character. The order of characters consisting of a word cannot be randomly changed. In other words, the appearance probability of each character is not uniform. For example, the language of a text or document to be processed includes a total of K characters. If all of the K characters are uniformly used to constitute words, the provability of a word consisting of M characters can be expressed by K^{M}. However, the number of words actually used or registered in a dictionary is not so large.

For example, Japanese language is known as a representative agglutinative language. The number of Japanese characters usually used in texts or documents rises up to approximately 6,000. If all of the Japanese characters are uniformly or randomly used to constitute words, the total number of resultant Japanese words consisting of two characters will rise up to (6,000)²=36,000,000. Similarly, a huge number of words will be produced for 3-, 4-, 5-, - - - character words. However, the total number of actually used Japanese words is several hundreds of thousands (e.g., 200,000˜300,000 according to a Japanese language dictionary “Kojien”).

A probability of a character “a” followed by another character “b” is expressed by a reciprocal number of the character type (i.e., 1/K), if all of the characters are uniformly used.

For example, a character string “ [symbol] ” is a Japanese word. The joint probability of a character “ [symbol] ” following after a character “ [symbol] ” is expressed by P [symbol] According to all of the Japanese words, the joint probability P [symbol] is larger than 1/K=1/6,000. The joint probability P [symbol] should be a more higher value since the presence of two characters “ [symbol] ” is given as a condition. On the other hand, a character string “ [symbol] ” is not recognized or registered as a Japanese word. Therefore, the joint probability P [symbol] should approach to 0.

On the other hand, a relatively free combination is allowed to constitute a sentence. A character string “ [symbol] [symbol] (This is a book of mathematics)” is a Japanese sentence. A word “ [symbol] (mathematics)” involved in this sentence can be freely changed to other word. For example, this sentence can be rewritten into “ [symbol] [symbol] (This is a book of music)”.

The joint probability P [symbol] is an appearance probability of “ [symbol] ” appearing after a character string “ [symbol] ”. According to the above example, the joint probability P [symbol] is very low. The joint probability of two neighboring characters appearing in a given text (or document) data is referred to as character joint probability. In other words, the character joint probability represents the degree (or tendency) of coupling between two neighboring characters. Thus, the present invention utilizes the character joint probability to divide or segment a character string (e.g., a sentence) of an agglutinative language into a plurality of words.

Regarding calculation of the character joint probability, its accuracy can be enhanced by collecting or preparing a sufficient volume of database. The character joint probability can be calculated statistically based on the document database.

Hereinafter, preferred embodiments of the present invention will be explained with reference to the attached drawings.

### First Embodiment

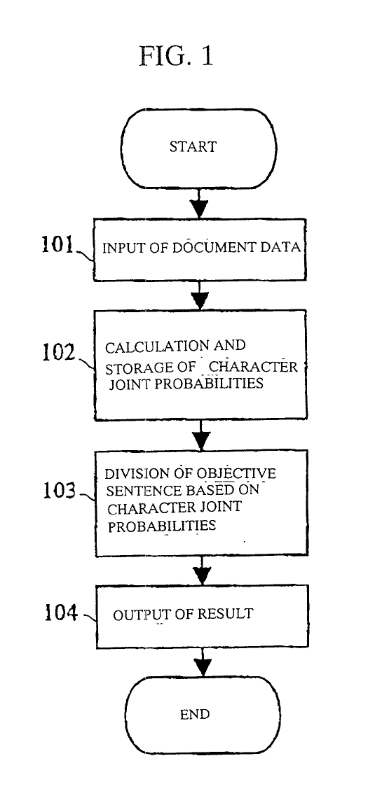

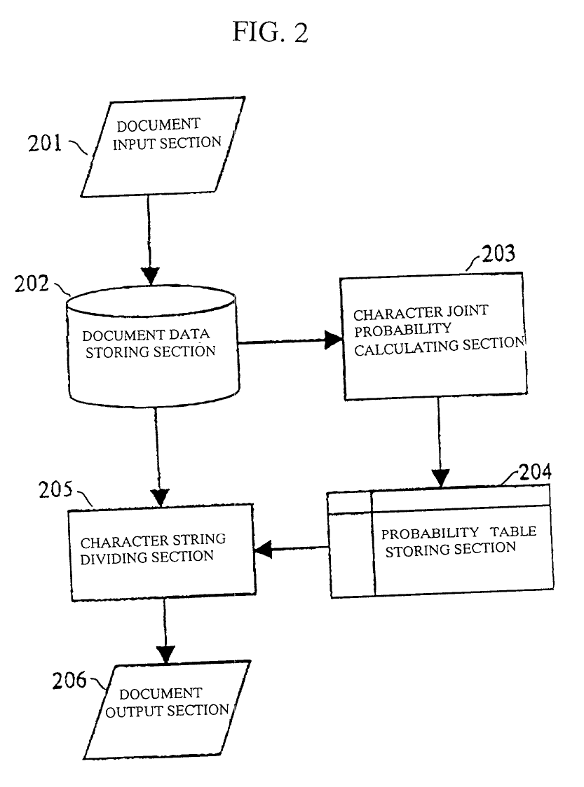

FIG. 1 is a flowchart showing a character string dividing or segmenting procedure in accordance with a first embodiment of the present invention. FIG. 2 is a block diagram showing an arrangement of a character string dividing system in accordance with the first embodiment of the present invention.

A document input section 201 inputs electronic data of an objective document (or text) to be processed. A document data storing section 202, serving as a database of document data, stores the document data received from the document input section 201. A character joint probability calculating section 203, connected to the document data storing section 202, calculates a character joint probability of any two characters based on the document data stored in the document data storing section 202. Namely, a probability of two characters existing as neighboring characters is calculated based on the document data stored in the database. A probability table storing section 204, connected to the character joint probability calculating section 203, stores a table of character joint probabilities calculated by the character joint probability calculating section 203. A character string dividing section 205 receives a document from the document data storing section 202 and divides the received document into several words with reference to the character joint probabilities stored in the probability table storing section 204. A document output section 206, connected to the character string dividing section 205, outputs a result of the processed document.

The processing procedure of the above-described character string dividing system will be explained with reference to a flowchart of FIG. 1.

Step 101: a document data is input from the document input section 201 and stored in the document data storing section 202.

Step 102: the character joint probability calculating section 203 calculates a character joint probability between two neighboring characters involved in the document data. The calculation result is stored in the probability table storing section 204. Details of the calculation method will be explained later.

Step 103: the document data is read out from the document data storing section 202 and is divided or segmented into several words with reference to the character joint probabilities stored in the probability table storing section 204. More specifically, a character joint probability of two neighboring characters is checked with reference to the table data. Then, the document is divided at a portion where the character joint probability is low.

Step 104: the divided document is output from the document output section 206.

The character string dividing system of the first embodiment of the present invention, as explained above, calculates a character joint probability of two neighboring characters involved in a document to be processed. The character joint probabilities thus calculated are used to determine division portions where the objective character string is divided or segmented into several words.

Next, details of the processing procedure in the step 102 will be explained. According to the first embodiment of the present invention, a character joint probability between a character Ci−1 and a character Ci is expressed as a conditional probability as follows.

P(Ci|C1C2 - - - Ci−1) (1)

where “i” is a positive integer, and the character Ci follows a character string C1 C2 - - - Ci−1.

The calculation for the joint probability expressed by the formula (1) requires a great amount of large memory spaces. The conditional probability of a character (or word) string expressed by the formula (1) approximates to a sequence of N characters which is generally referred to as N-gram (N=1, 2, 3, 4, - - - ). The conditional probability using the N-gram is defined as an appearance probability of character Ci which appears after a character string C_{i-N+1} - - - Cᵢ₋₁. The character string C_{i-N+1} - - - Cᵢ₋₁ is a sequence of a total of (N−1) characters arranged in this order. More specifically, the conditional probability using the N-gram is an appearance probability of N^{th} character which appears after a character string consisting of 1st to (N−1)^{th} characters of the N-gram. This is expressed by the following formula (2).

P(Ci|C_{i-N+1} - - - Cᵢ₋₁) (2)

The probability of the N-gram can be estimated as follows (refer to “Word and Dictionary” written by Yuji Matsumoto et al, published by Iwanami Shoten, Publishers, in 1997).

P(Ci|C_{i-N+1} - - - Cᵢ₋₁)=Count(C_{i-N+1} - - - Cᵢ)/Count(C_{i-N+1} - - - Cᵢ₋₁) (3)

where Count(C1·C2· - - - Cₘ) represents an appearance frequency (i.e., the number of appearance times) that a character string C1·C2· - - - Cₘ appears in a data to be checked.

In the calculation of the N-gram, a total of (N−1) specific symbols are added before and after a character string (i.e., a sentence) to be calculated. In general, a probability of a head character or a tail character of a sentence is calculated based on the N-gram involving the specific symbols. For example, it is now assumed that a Japanese sentence “ [symbol] (This is a book)” is given as a sample (N=3). Specific symbols ## are added before and after the given character string to produce a character string “## [symbol] ##”, from which a total of seven 3-grams are derived as follows.

“## [symbol] ”, “# [symbol] ”, “ [symbol] ”, “ [symbol] ”, “ [symbol] ”, “ [symbol] #”, “ [symbol] ##”

On the other hand, according to the first embodiment of the present invention, the calculation of the N-gram is performed in the following manner.

A total of (N−2) specific symbols are added before a character string to be calculated. And, no specific symbol is added after the character string to be calculated. In this case, N−2 is not smaller than 0 (i.e., N−2≧0, thus N−2 is regarded as 0 when N=1). The reason why no specific symbol is added after the character string to be calculated is that the last character of a sentence is always an end of a word. In other words, it is possible to omit the calculation for obtaining the joint probability between the last character of a sentence and the specific symbol. Meanwhile, regarding the front portion of a sentence, it is apparent that a head of a sentence is a beginning of a word. Thus, it is possible to reduce the total number of specific symbols to be added before a sentence. To calculate a joint probability between a head character and the next character of a sentence, it is necessary to produce an N-gram including a total of (N−2) specific symbols. This is why this embodiment adds a total of (N−2) specific symbols before a character string to be calculated.

Returning to the 3-gram example of “ [symbol] ”, it is apparent that a head of this sentence is a beginning of a word. Thus, it is not necessary to calculate a joint probability between “##” and “ [symbol] ” in the first 3-gram “## [symbol] ” of the seven derived 3-grams derived from the objective sentence “## [symbol] [symbol] ##.” However, it is necessary to calculate a joint probability between “# [symbol] ” and “ [symbol] ” in the second 3-gram “# [symbol] ” of the seven derived 3-grams. Accordingly, it is concluded that (N−2) is an appropriate number of specific symbols to be added before a character string to be calculated. Regarding the end portion of this sentence, it is not necessary to calculate a joint probability between “ [symbol] ” and “#” in the sixth 3-gram “ [symbol] #” as well as a joint probability between “ [symbol] ” and “##” in the seventh 3-gram “ [symbol] ##.” Hence, no specific symbols should be added after a character string to be calculated.

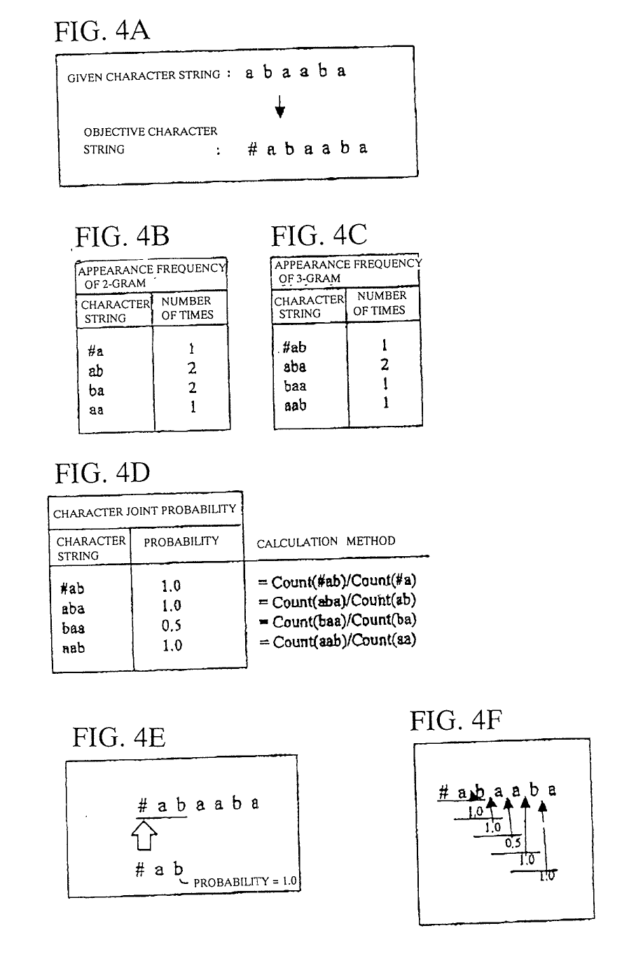

The step 102 shown in FIG. 1 is equivalent to calculating the formula (3) and then storing the calculated result together with a corresponding sequence of N characters (i.e., a corresponding N-gram) into the probability table storing section 204. FIG. 4D shows a character joint probability stored in the probability table storing section 204, in which each N gram and its calculated probability are stored as a pair. This storage is advantageous in that the search can be performed by using a sequence of characters and a required memory capacity is relatively small.

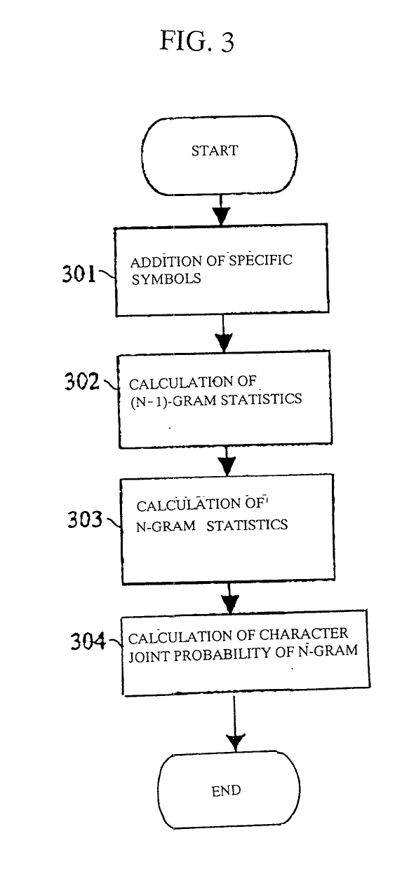

FIG. 3 is a flowchart showing a calculation procedure of the step 102.

Step 301: a total of (N−2) specific symbols are added before a head of each sentence of an objective document.

Step 302: a (N−1)-gram statistics is obtained. More specifically, a table is produced about all sequences of (N−1) characters appearing in the objective document. This table describes an appearance frequency (i.e., the number of appearance times) for each sequence of (N−1) characters. The appearance frequency indicates how often each sequence of (N−1) characters appears in the objective document. In general, as described in “Language Information Processing” written by Shin Nagao et al, published by Iwanami Shoten, Publishers, in 1998, obtaining the statistics of a N-gram is simply realized by preparing a table capable of expressing K^{N} where K represents the number of character kinds and N is a positive integer. An appearance frequency of each N-gram is counted by using this table. Or, the appearance frequency of each N-gram can be counted by sorting all sequences of N characters involved in the objective document.

Step 303: a N-gram statistics is obtained. Namely, a table is produced about all sequences of N characters appearing in the objective document. This table describes an appearance frequency (i.e., the number of appearance times) of each sequence of N characters about how often each sequence of N characters appears in the objective document. In this respect, step 303 is similar to step 302.

Step 304: it is assumed that X represents an appearance frequency of each character string consisting of N characters which was obtained as one of N-gram statistics. Next, for a character string consisting of 1^{st} to (N−1)^{th} characters of each N-gram, the appearance frequency is checked based on the (N−1)-gram statistics obtained in step 302. Y represents the thus obtained appearance frequency of the character string consisting of 1^{st} to (N−1)^{th} characters of each N-gram. X/Y is a value of the formula (3). Thus, a value X/Y is stored in the probability table storing section 204.

The value of the formula (3) can be obtained in a different way. For example, the formation of the (N−1)-gram may be omitted because calculation of the appearance frequency of the (N−1)-gram can be easily done based on the N-gram as it involves character strings of (N−1) grams.

Hereinafter, an example of calculation for obtaining the character joint probability will be explained.

For simplification, it is now assumed that a character string “abaaba” is an entire document given as an example. The character joint probability is now calculated based on 3-gram (i.e., N-gram of N=3).

First, according to the step 301, a total of (N−2) specific symbols are added before the head of the given sentence (i.e., character string “abaaba”). In this case, N−2=3−2=1. Thus, only one specific symbol (e.g., #) is added before the head of the given sentence, as shown in FIG. 4A. The specific symbol (#) is the one selected from the characters not involved in the given sentence (i.e., character string “abaaba”).

Next, according to the step 302, the 2-gram statistics is obtained. Namely, the appearance frequency of each character string consisting of two characters involved in the given sentence is checked. FIG. 4B shows the obtained appearance frequency of each character string consisting of two characters.

Next, according to the step 303, the 3-gram statistics is obtained to check the appearance frequency of each character string consisting of three characters involved in the given sentence. FIG. 4C shows the obtained appearance frequency of each character string consisting of three characters.

Then, according to the step 304, the value of formula (3) is calculated based on the data of FIGS. 4B and 4C for each 3-gram (i.e., a sequence of three characters). FIG. 4D shows the thus obtained character joint probabilities of respective 3-grams. The above-described procedure is the processing performed in the step 102 shown in FIG. 1.

Hereinafter, details of step 103 shown in FIG. 1 will be explained. The step 103 is a process for checking the joint probability between any two characters consisting of an objective sentence. And then, with reference to the obtained joint probabilities, step 103 determines appropriate portion or portions where this sentence should be divided.

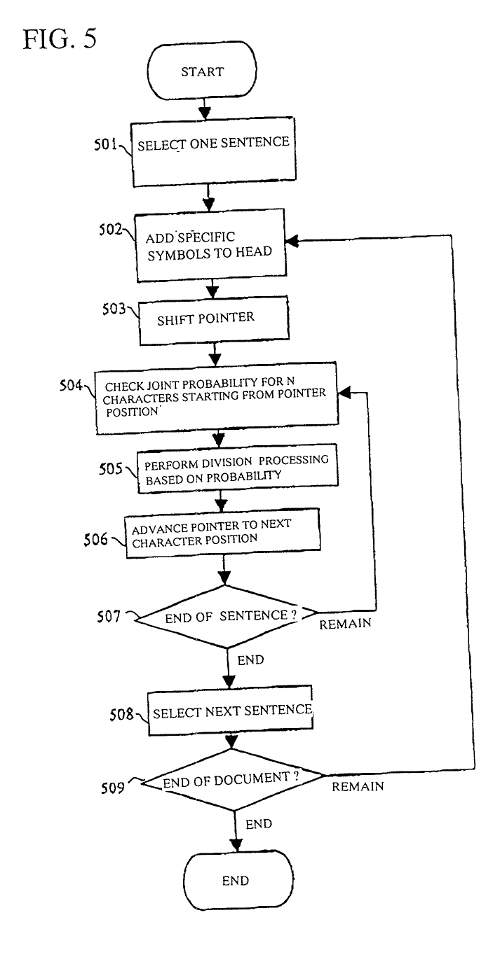

FIG. 5 is a flowchart showing the detailed procedure of step 103. According to the first embodiment of the present invention, δ represents a threshold which is determined beforehand.

Step 501: an arbitrary sentence is selected from a given document.

Step 502: a total of (N−1) specific symbols are added before the head of the selected sentence.

Step 503: a pointer is moved on the first specific symbol added before the head of the sentence.

Step 504: for a character string consisting of N characters starting from the pointer position, a character joint probability calculated in the step 102 is checked.

Step 505: if the character joint probability obtained in step 504 is less than the threshold δ, it can be presumed that an appropriate division point exists between a (N−1)^{th} character and a N^{th} character in this case (i.e., when the pointer is located on the first specific symbol). Thus, the sentence is divided or segmented into a first part ending at the (N−1)^{th} character and a second part starting from the N^{th} character. If the character joint probability obtained in step 504 is not less than the threshold δ, it is concluded that no appropriate division point exists between the (N−1)^{th} character and the N^{th} character. Thus, no division of the sentence is done.

Step 506: the pointer is advanced one character forward.

Step 507: when the N^{th} character counted from the pointer position exceeds the end of the sentence, it is regarded that all of the objective sentence is completely processed. Then, the calculation procedure proceeds to step 508. Otherwise, the calculation procedure jumps (returns) to the step 504.

Step 508: a next sentence is selected from the given document.

Step 509: if there is no sentences remaining, this control routine is terminated. Otherwise, the calculation procedure returns to the step 502.

Through the above-described procedure, a division point of a given sentence is determined. An example of calculation will be explained hereinafter.

Returning to the example of a character string “abaaba” (N=3) shown in FIG. 4A, it is now assumed that the joint probabilities of respective 3-grams (i.e., character strings each consisting of 3 characters) are already calculated as shown in FIG. 4D.

In this case, according to the step 501, the character string “abaaba” is selected as no other sentences are present.

Next, according to the step 502, a specific symbol (#) is added before the sentence “abaaba” as shown in FIG. 4A.

Next, according to the step 503, the pointer is moved on the first specific symbol added before the head of the sentence as shown in FIG. 4E. Then, the probability of a first 3-gram (i.e., #ab) is checked with reference to the table shown in FIG. 4D. The probability of “#ab” is 1.0. According to this embodiment, the threshold δ is 0.7. Therefore, the probability of “#ab” is larger than the threshold δ(=0.7). It is thus concluded that the sentence is not divided between the characters “#a” and “b.”

Similarly, the procedure from the step 504 to the step 507 is repeated in the same manner for each of the remaining 3-grams. The probabilities of character strings “aba”, “baa”, and “aab” are 1.0, 0.5, and 1.0 respectively, as shown in FIG. 4F. According to this result, the joint probability between “ba” and “a” is 0.5 which is less than the threshold δ (=0.7). Thus, it is concluded that an appropriate division point exists between the “ba” and “a”, according to which the sentence “abaaba” is divided or segmented into two parts “aba” and “aba.”

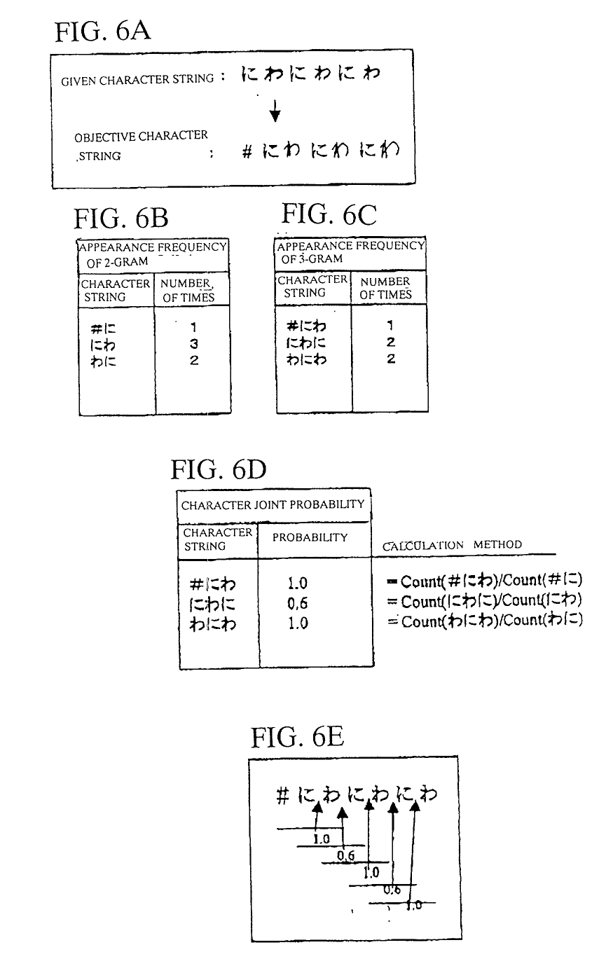

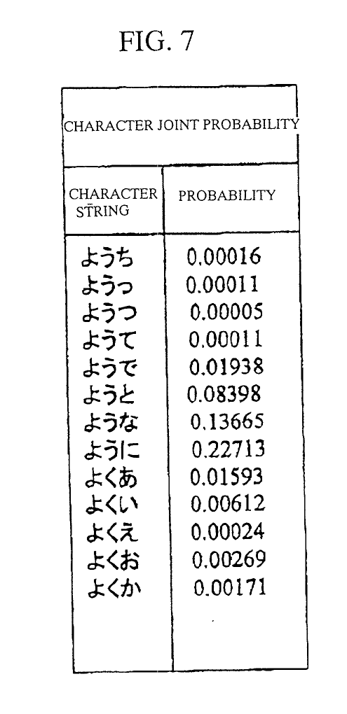

Next, an example of Japanese sentence will be explained. A given sentence is a character string “ [symbol] [symbol] =two birds in a garden).” FIGS. 6A through 6E show a detailed calculation procedure for this Japanese sentence. FIG. 6A shows an objective sentence with a specific symbol added before the head of the given Japanese sentence. FIGS. 6B and 6C show calculation result of appearance probabilities for respective 2-grams and 3-grams involved in the objective sentence. FIG. 6D shows character joint probabilities calculated for all of the 3-grams involved in the objective sentence. FIG. 6E shows a relationship between respective 3-grams and their probabilities. When the threshold is 0.7 (i.e., δ=0.7), the sentence is divided or segmented into three parts of “ [symbol] ”, “ [symbol] ”, and “ [symbol] ” as a result of calculation referring to the character joint probabilities shown in FIG. 6D.

The above-described examples are simple sentences involving a relatively small number of characters. However, a practical sentence involves a lots of characters. Especially, a Japanese sentence generally involves kanji (Chinese characters), hiragana, and katakana characters. Therefore, for processing the Japanese sentences which include many kinds of Japanese characters, it is necessary to prepare many sentences for learning purposes.

FIG. 7 shows a practical example of character joint probabilities obtained from many Japanese documents involving 10 millions of Japanese characters generally used in newspapers.

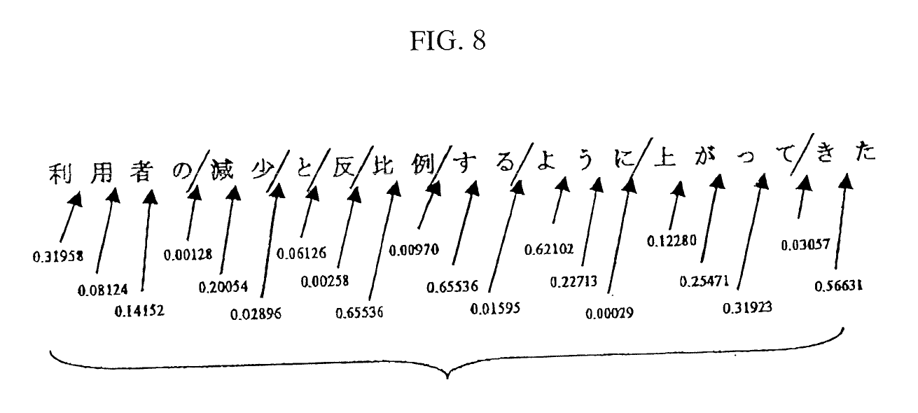

FIG. 8 shows a calculation result on a given sentence “ [symbol] [symbol] [symbol] (Its increase is inverse proportion to reduction of the number of users)” based on the joint probability data shown in FIG. 7. The threshold determining each division point is set to 0.07 (i.e., δ=0.07) in this case. As a comparison between each joint probability and the threshold, the given sentence is divided or segmented into several parts as shown in FIG. 8.

As described above, the above-described first embodiment of the present invention calculates character joint probabilities between any two adjacent characters involved in an objective document. The calculated probabilities are used to determine division points where the objective document should be divided. This method is useful in that all probabilities of any combinations of characters appearing in the objective document.

The present invention is not limited to the system which calculates character joint probabilities between any two adjacent characters only from the objective document. For example, it is possible to calculate character joint probabilities based on a bunch of documents beforehand. The obtained character joint probabilities can be used to divide another documents. This method can be effectively applied to a document database whose volume or size increases gradually. In this case, a combination of characters appearing in an objective document may not be found in the document data used for obtaining (learning) the character joint probabilities. This is known as a problem caused in smoothing of N-gram. Such a problem, however, will be resolved by the method described in the reference document “Word and Dictionary” written by Yuji Matsumoto et al, published by Iwanami Shoten, Publishers, in 1997).

For example, it is preferable to estimate a joint probability of any two neighboring characters not appearing in the database based on the already calculated joint probabilities for the neighboring characters stored in the document database.

As described above, the first embodiment of the present invention inputs an objective document, calculates character joint probabilities between any two characters appearing in an objective document, divides or segments the objective document into several parts (words) with reference to the calculated character joint probabilities, and outputs a division result of divided document.

Thus, the first embodiment of the present invention provides a character string dividing system for segmenting a character string into a plurality of words, comprising input section means (201) for receiving a document, document data storing means (202) serving as a document database for storing a received document, character joint probability calculating means (203) for calculating a joint probability of two neighboring characters appearing in the document database, probability table storing means (205) for storing a table of calculated joint probabilities, character string dividing means (205) for segmenting an objective character string into a plurality of words with reference to the table of calculated joint probabilities, and output means (206) for outputting a division result of the objective character string.

Furthermore, the first embodiment of the present invention provides a character string dividing method for segmenting a character string into a plurality of words, comprising a step (102) of statistically calculating a joint probability of two neighboring characters appearing in a given document database, and a step (103) of segmenting an objective character string into a plurality of words with reference to calculated joint probabilities so that each division point of the objective character string is present between two neighboring characters having a smaller joint probability.

Furthermore, the first embodiment of the present invention provides a character string dividing method for segmenting a character string into a plurality of words, comprising a step (102) of statistically calculating a joint probability of two neighboring characters (Cᵢ₋₁Cᵢ) appearing in a given document database, the joint probability P(Ci|C_{i-N+1} - - - Cᵢ₋₁)=Count(C_{i-N+1} - - - Cᵢ)/Count(C_{i-N+1} - - - C ᵢ₋₁) being calculated as an appearance probability of a specific character string (C_{i-N+1} - - - Cᵢ₋₁) appearing immediately before a specific character (Cᵢ), the specific character string including a former one (Cᵢ₋₁) of the two neighboring characters as a tail thereof and the specific character being a latter one (Cᵢ) of the two neighboring characters, and a step (103) of segmenting an objective character string into a plurality of words with reference to calculated joint probabilities so that each division point of the objective character string is present between two neighboring characters having a smaller joint probability.

Moreover, the first embodiment of the present invention provides a character string dividing method for segmenting a character string into a plurality of words, comprising a step (102) of statistically calculating a joint probability of two neighboring characters appearing in a given document database prepared for learning purpose, and a step (103) of segmenting an objective character string into a plurality of words with reference to calculated joint probabilities so that each division point of the objective character string is present between two neighboring characters having a smaller joint probability, wherein, when the objective character string involves a sequence of characters not involved in the document database, a joint probability of any two neighboring characters not appearing in the database is estimated based on the calculated joint probabilities for the neighboring characters stored in the document database.

In this manner, the first embodiment of the present invention provides an excellent character string division method without using any dictionary, bringing large practical merits.

### Second Embodiment

The system arrangement shown in FIG. 2 is applied to a character string dividing system in accordance with a second embodiment of the present invention. The character string dividing system of the second embodiment operates differently from that of the first embodiment in using a different calculation method. More specifically, steps 102 and 103 of FIG. 1 are substantially modified in the second embodiment of the present invention.

According to the first embodiment of the present invention, calculation of character joint probabilities is done based on N-grams. The used probability is an appearance probability of the character Ci which appears after a character string C_{i-N+1} - - - Cᵢ₋₁ (refer to the formula (2) ). For example, to calculate a joint probability between character strings “abc” and “def” of a given sentence “abcdef”, the probability of a character “d” appearing after the character string “abc” is used. This method is basically an improvement of the N-gram method which is a conventionally well-known technique. The N-gram method is generally used for calculating a joint naturalness of two words or two characters, and for judging adequateness of the calculated result considering the meaning of the entire sentence. Furthermore, the N-gram method is utilized for predicting a next-coming word or character with reference to word strings or character strings which have already appeared.

Accordingly, the following probability formula is generally used.

$${\prod }_{i = 1}^{m} P ( ϖi \vert ϖ1ϖ2⋯ \overline{ϖ} i - 1 )$$

However, the above-described first embodiment modifies the above formula into the following formula.

$${\prod }_{i = 1}^{m} P ( {ϖ}_{i - N + 1} … {ϖ}_{i - 1} )$$

The formula (2) used in the first embodiment is equal to the inside part of the product symbol II.

From this premise, the first embodiment obtains an appearance probability of a character Ci which appears after a character string C_{i-N+1} - - - Cᵢ₋₁. The conditional portion C_{i-N+1} - - - Cᵢ₋₁ is a character string consisting of a plurality of characters. Thus, the first embodiment obtains an appearance probability of a specific character which appears after a given condition (i.e., a given character string).

However, the present invention utilizes the character joint probability to judge a joint probability between two characters in a word or a joint probability between two words. Hence, second embodiment of the present invention expresses a joint probability of a character Ci−1 and a character Ci by an appearance probability of a certain character string under a condition that this certain character string has appeared, not by an appearance probability of a certain character under a condition that a certain character has appeared.

More specifically, it is now assumed that a character string consisting of n characters Ci−n - - - Ci−1 has appeared. The second embodiment calculates an appearance probability of a character string consisting of m characters Ci - - - Ci+ m−1 under a condition that a character string consisting of n characters Ci+n - - - Ci− 1 has appeared.

Like the formula (2) used in the first embodiment, this probability is expressed by the following formula (4).

$$P ( \underbrace{{C}_{i} ⋯ {C}_{i + m - 1}}_{m} \vert \underbrace{{C}_{i - n} ⋯ {C}_{i - 1} )}_{n} \qquad ( 4 )$$

For example, to calculate a joint probability between a character string “abc” and a character string “def” of a sentence “abcdef” appearing in a document, an appearance probability of the character string “def” is referred to when the character string “abc” has appeared. This is an example of n=3 and m=3. When m=1, the formula (4) is substantially equal to the formula (2) used in the first embodiment.

The first embodiment is regarded as a forward (i.e., front→rear) directional calculation of the probability. For example, the first probability is a joint probability between a first character string located at the head of a sentence and the next character string. The conditions n=1 and m>1 of the formula (4) approximate to a reverse (i.e., rear→front) directional calculation of the probability.

For example, to calculate a joint probability between a character string “abc” and a character string “def” of a sentence “abcdef” appearing in a document, a probability to be obtained is an appearance probability of the character string “def” which appears after a character “c” in the case of n=1 and m=3. This approximates to a probability of the character “c” which is present before the character string “def.” This corresponds to a reverse directional calculation of the character joint probability. However, to perform the calculation of the formula (4), it is necessary to obtain (n+m)-gram statistics. When n≧2 and m≧2, obtaining the 4(or more large)-grams statistics is definitely necessary. This requires a very large memory space.

In view of the foregoing, the second embodiment of the present invention proposes to use the following formula (5) which approximates to the above-described formula (4).

P(Ci|Ci−n - - - Ci−1)×P(Ci−1|Ci - - - Ci+m−1) (5)

The formula (5) is a product of a first factor and a second factor. The first factor represents a forward directional probability that a specific character appears after a character string consisting of n characters. The second factor represents a reverse direction probability that a specific character is present before a character string consisting of m characters.

FIG. 14 shows a relationship between each factor and a corresponding character string. For example, in the case of calculating a joint probability between a character string “abc” and a character string “def” of a sentence “abcdef” appearing in a document, it means to calculate an appearance probability of a character string “abc” which appears after a character “d” as the first factor (i.e., forward directional one) and also calculate an appearance probability of a character “c” which is present before a character string “def” as the second factor (i.e., reverse directional one). Then, a product of the first and second factors is obtained.

The probability defined by the formula (5) can by calculated by obtaining a (n+1)-gram for the first factor and a (m+1)-gram for the second factor by using the following formula.

$$\frac{Count ( {C}_{i - n} ⋯ {C}_{i} )}{\underbrace{Count ( {C}_{i - n} ⋯ {C}_{i - 1} )}_{1 st}} \times \frac{Count ( {C}_{i - 1} ⋯ {C}_{i + m - 1} )}{\underbrace{Count ( {C}_{i} ⋯ {C}_{i + m - 1} )}_{2 nd}} \qquad ( 6 )$$

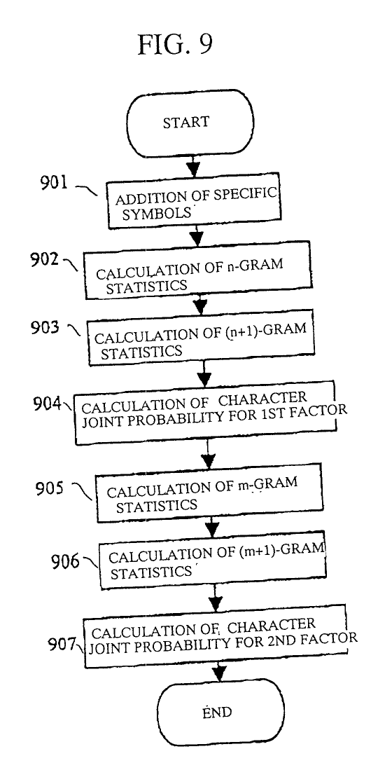

The calculation result of the formula (6) is stored together with the sequence of (n+1) characters and the sequence of (m+1) characters into the probability table storing section 204. This procedure is a modified step 102 of FIG. 1 according to the second embodiment. Accordingly, the probability table storing section 204 possesses a table for the sequence of (n+1) characters and another table for the sequence of (m+1) characters. When n≠m, the above calculation can be realized according to the procedure shown in FIG. 9.

Step 901: a total of (n−2) specific symbols are added before the head of each sentence of an objective document and a total of (m−2) specific symbols are added after the tail of this sentence. According to the second embodiment of the present invention, the joint probability is calculated in both of the forward and reverse directions. This is why a total of (m−2) specific symbols are added after the tail of the sentence.

Step 902: a n-gram statistics is obtained. Namely, a table is produced about all sequences of n characters appearing in the objective document. This table describes an appearance frequency (i.e., the number of appearance times) of each sequence of n characters about how often each sequence of n characters appears in the objective document.

Step 903: a (n+1)-gram statistics is obtained. Namely, a table is produced about all sequences of (n+1) characters appearing in the objective document. This table describes an appearance frequency (i.e., the number of appearance times) of each sequence of (n+1) characters about how often each sequence of (n+1) characters appears in the objective document.

Step 904: it is assumed that X represents an appearance frequency of each character string consisting of (n+1) characters which was obtained as one of (n+1)-gram statistics. Next, for a character string consisting of 1^{st} to n^{th} characters of each (n+1)-gram, the appearance frequency is checked based on the n-gram statistics obtained in step 902. Y represents the thus obtained appearance frequency of the character string consisting of 1^{st} to n^{th} characters of each (n+1)-gram. X/Y is a value of the first factor of the formula (6). Thus, the value X/Y is stored in the table for the first factor (i.e., for the sequence of (n+1) characters) in the probability table storing section 204.

Step 905: a m-gram statistics is obtained. Namely, a table is produced about all sequence of m characters appearing in the objective document. This table describes an appearance frequency (i.e., the number of appearance times) of each sequence of m characters about how often each sequence of m characters appears in the objective document.

Step 906: a (m+1)-gram statistics is obtained. Namely, a table is produced about all sequences of (m+1) characters appearing in the objective document. This table describes an appearance frequency (i.e., the number of appearance times) of each sequence of (m+1) characters about how often each sequence of (m+1) characters appears in the objective document.

Step 907: it is assumed that X represents an appearance frequency of each character string consisting of (m+1) characters which was obtained as one of (m+1)-gram statistics. Next, for a character string consisting of 2^{nd} to (m+1)^{th} characters of each (m+1)-gram, the appearance frequency is checked based on the m-gram statistics obtained in step 905. Y represents the thus obtained appearance frequency of the character string consisting of 2^{nd} to (m+1)^{th} characters of each (m+1)-gram. X/Y is a value of the second factor of the formula (6). Thus, the value X/Y is stored in the table for the second factor (i.e., for the sequence of (m+1) characters) in the probability table storing section 204.

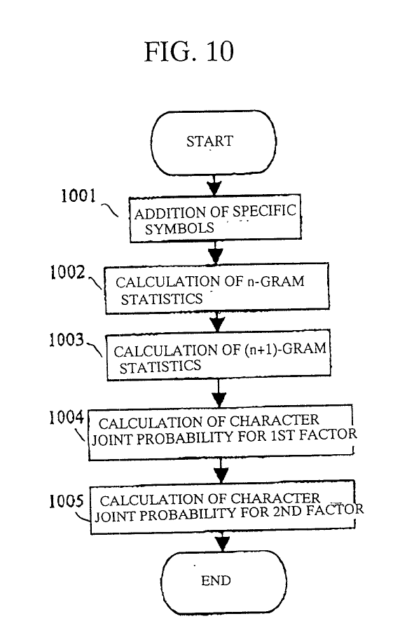

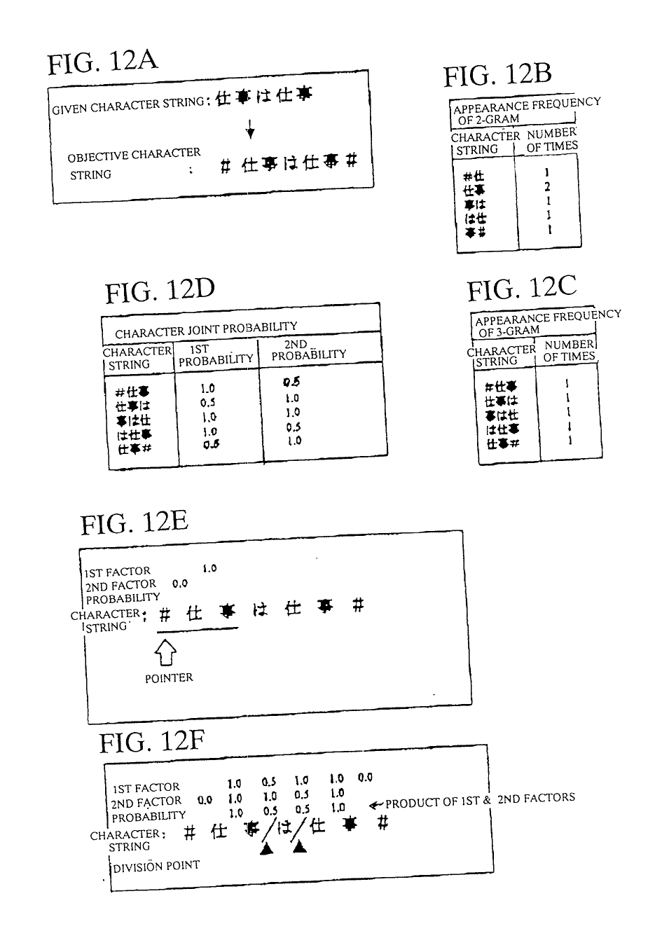

When n=m, the probability table storing section 204 possesses only one table for the sequence of n characters. FIG. 12D shows a detailed structure of the table for the sequence of (n+1) characters, wherein each sequence of n characters is paired with probabilities of first and second factors. When n=m, the above calculation procedure can be simplified as shown in FIG. 10.

Step 1001: a total of (n−2) specific symbols are added before the head of each sentence of an objective document. Similarly, a total of (n−2) specific symbols are added after the tail of this sentence.

Step 1002: a n-gram statistics is obtained. Namely, a table is produced about all sequences of n characters appearing in the objective document. This table describes an appearance frequency (i.e., the number of appearance times) of each sequence of n characters about how often each sequence of n characters appears in the objective document.

Step 1003: a (n+1)-gram statistics is obtained. Namely, a table is produced about all sequences of (n+1) characters appearing in the objective document. This table describes an appearance frequency (i.e., the number of appearance times) of each sequence of (n+1) characters about how often each sequence of (n+1) characters appears in the objective document.

Step 1004: it is assumed that X represents an appearance frequency of each character string consisting of (n+1) characters which was obtained as one of (n+1)-gram statistics. Next, for a character string consisting of 1^{st} to n^{th} characters of each (n+1)-gram, the appearance frequency is checked based on the n-gram statistics obtained in step 1002. Y represents the thus obtained appearance frequency of the character string consisting of 1^{st} to n^{th} characters of each (n+1)-gram. X/Y is a value of the first factor of the formula (6). Thus, the value X/Y is stored in the portion for the probability of the first factor in the probability table storing section 204.

Step 1005: it is assumed that X represents an appearance frequency of each character string consisting of (n+1) characters which was obtained as one of (n+1)-gram statistics. Next, for a character string consisting of 2^{nd} to (n+1)^{th} characters of each (n+1)-gram, the appearance frequency is checked based on the n-gram statistics obtained in step 1002. Y represents the thus obtained appearance frequency of the character string consisting of 2^{nd} to (n+1)^{th} characters of each (n+1)-gram. X/Y is a value of the second factor of the formula (6). Thus, the value X/Y is stored in the portion for the probability of the second factor in the probability table storing section 204.

Through the above calculation procedure, preparation for finally obtaining the value of the formula (6) is accomplished. The actual value of the formula (6) is calculated according to the following division process.

The second embodiment of the present invention modifies the step 103 of FIG. 1 in the following manner.

The step 103 of FIG. 1 is a procedure for checking a joint probability of any two characters constituting a sentence to be processed with reference to the character joint probabilities calculated in the step 102, and then for dividing the sentence at appropriate division points. When n≠m, the processing of step 103 is performed according to the flowchart of FIG. 11.

Step 1101: an arbitrary sentence is selected from a given document.

Step 1102: like the step 1101 of FIG. 10, a total of (n−2) specific symbols are added before the head of the selected sentence and a total of (m−2) specific symbols are added after the tail of the this sentence.

Step 1103: a pointer is moved on the first specific symbol added before the head of the sentence.

Step 1104: for a character string consisting of (n+1) characters starting from the pointer position, a character joint probability for the first factor stored in the probability table storing section 204 is checked. The obtained value is stored as a joint probability (for the first factor) between the n^{th} character and the (n+1)^{th} character under the condition that the pointer is located on the first specific symbol added before the head of the sentence. In this case, it is assumed that a joint probability between the specific symbol and the sentence is 0.

Step 1105: for a character string consisting of (m+1) characters starting from the pointer position, a character joint probability for the second factor stored in the probability table storing section 204 is checked. The obtained value is stored as a joint probability (for the second factor) between the 1^{st} character and the 2^{nd} character under the condition that the pointer is located on the first specific symbol added before the head of the sentence. In this case, it is assumed that a joint probability between the specific symbol and the sentence is 0.

Step 1106: the pointer is advanced one character forward.

Step 1107: for any two adjacent characters, the value of formula (6) is calculated by taking a product of the probability of the first factor and the probability of the second factor. If the calculated value of formula (6) is less than a predetermined threshold δ, it can be presumed that an appropriate division point exists. Thus, the sentence is divided at a portion where the value of formula (6) is less than the predetermined threshold δ. When the value of formula (6) is not less than the predetermined threshold δ, no division of the sentence is done.

Step 1108: when the pointer indicates the end of the sentence, it is regarded that all of the objective sentence is completely processed. Then, the calculation procedure proceeds to step 1109. Otherwise, the calculation procedure jumps (returns) to the step 1104.

Step 1109: a next sentence is selected from the given document.

Step 1110: if there is no sentences remaining, this control routine is terminated. Otherwise, the calculation procedure returns to the step 1102.

Through the above-described procedure, a division point of a given sentence is determined. When n=m, the procedure is done in the same manner.

Now a practical example will be explained. Only one character string “ [symbol] ” is given as an entire document. Based on this sample, a character joint probability for (n+1)-gram in the case of n=m=2, i.e., 3-gram, is calculated.

First, according to the step 1001, only one (i.e., n−2(>0)=1) specific symbol is added before and after the given sentence (i.e, the given character string), as shown in FIG. 12A. Although the second embodiment uses # as a specific symbol, the specific symbol should be selected from characters not appearing in the given sentence.

Next, according to the step 1002, 2-gram statistics is obtained. Namely, the appearance frequency (i.e., the number of appearance times) for all sequences consisting of two characters is checked as shown in FIG. 12B.

Similarly, according to the step 1003, 3-gram statistics is obtained. Namely, the appearance frequency (i.e., the number of appearance times) for all sequences consisting of three characters is checked as shown in FIG. 12C.

Next, according to the step 1004, for each of the obtained 3-grams, the value of the first factor of the formula (6) is calculated with reference to the data shown in FIGS. 12B and 12C. The calculated result is shown in a portion for the first factor in the table of FIG. 12D.

Next, according to the step 1005, for each of the obtained 3-grams, the value of the second factor of the formula (6) is calculated with reference to the data shown in FIGS. 12B and 12C. The calculated result is shown in a portion for the second factor in the table of FIG. 12D.

Regarding the table of FIG. 12D, it should be noted that the probability for the first factor and the probability for the second factor are obtained for different portions of a same 3-gram. For example, a character string “ [symbol] ” is a second 3-gram in the column for the character strings obtained from the given sentence. In this case, the probability for the first factor is a joint probability between “ [symbol] ” and “ [symbol] ”, while the probability for the second factor is a joint probability between “ [symbol] ” and “ [symbol] .”

After obtaining the above probability table, the calculation procedure proceeds to the routine shown in FIG. 11.

According to the step 1101, a sentence “ [symbol] ” is selected. Then, according to the step 1102, specific symbol (#) is added before and after this sentence, as shown in FIG. 12A. Then, according to the steps 1103 to 1105, probabilities of the first and second factors are obtained as shown in FIG. 12E. In this case, the probability of the second factor is 0 because a character joint probability between the specific symbol “#” and the character string “ [symbol] ” is 0. Then, according to the step 1106, the pointer is advanced one character forward. In this manner, the probabilities of the first and second factors are obtained by repetitively performing the steps 1104 and 1105 while shifting the pointer position step by step from the beginning to the end of the objective sentence.

Meanwhile, in the step 1107, the value of formula (6) for any two adjacent characters involved in the objective sentence is calculated by taking a product of the probabilities of corresponding first and second factors. FIG. 12F shows the probabilities of the first and second factors thus obtained together with the calculated values of formula (6). When the value of formula (6)for any two adjacent characters is less than the threshold δ (e.g., δ=0.6), the sentence is divided at this portion. FIG. 12F shows a divided character stream “ [symbol] #” resultant from the procedure of step 1107.

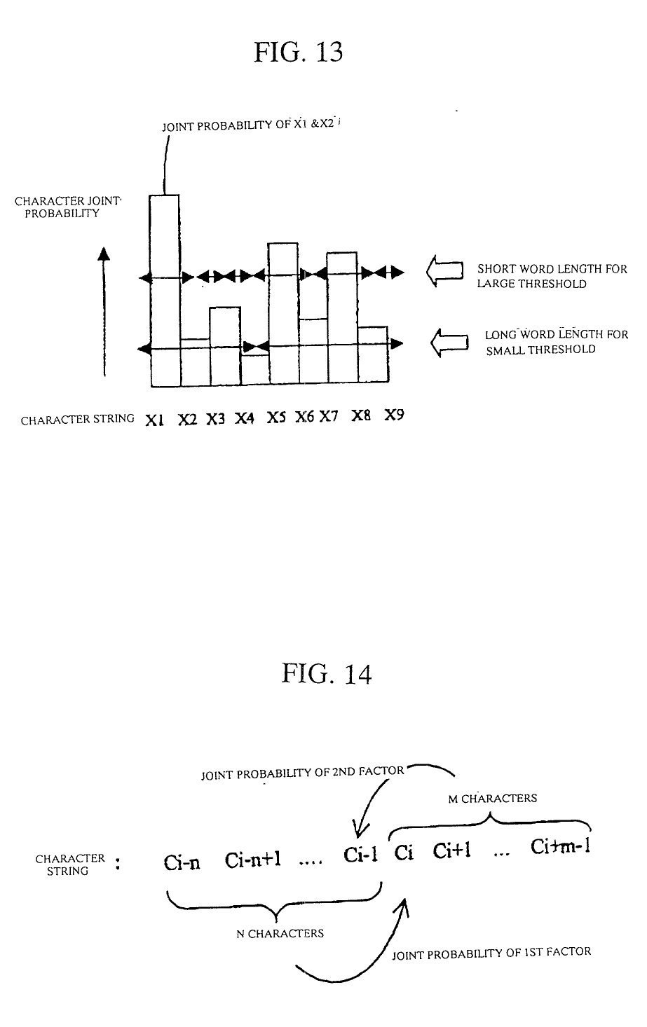

Regarding the threshold δ, its value is a fixed one determined beforehand. However, it is possible to flexibly determine the value of threshold δ with reference to the obtained probability values. In this case, an appropriate value for the threshold δ should be determined so that an average word length of resultant words substantially agree with a desirable value. More specifically, as shown in FIG. 13, when the threshold δ is large, the average word length of resultant words becomes short. When the threshold δ is small, the average word length of resultant words becomes long. Thus, considering a desirable average word length will derive an appropriate value for the threshold δ.

The above-described embodiments use one threshold. However, it is possible to use a plurality of thresholds based on appropriate standards. For example, Japanese sentences comprise different types of characters, i.e., hiragana and katakana characters in addition to kanji (Chinese) characters. In general, an average word length of hiragana (or katakana) words is longer than that of kanji (Chinese) characters. Thus, it is desirable to set a plurality of thresholds for different types of characters appearing in Japanese sentences.

Furthermore, in the case of many Japanese sentences, appropriate division points exist at portions where the character type changes in such a manner as kanji [symbol] hiragana, kanji [symbol] katakana, and hiragana [symbol] katakana. Considering this fact, it is preferable to reduce the threshold level for such changing points of character type than other threshold levels.

In addition to the head and tail of each sentence, comma, parentheses, and comparable symbols can be regarded as definite division points where the sentence is divided. It is thus possible to omit the calculation of probabilities for these prospective candidates for the division points.

For example, the character string “ [symbol] ” used in the above explanation of the second embodiment may have another form of “z,55 .” In this case, there are two character strings “ [symbol] ” and “ [symbol] .” So, the calculation of the second embodiment can be performed for each of two objective character strings “# [symbol] #” and “# [symbol] #.”

Furthermore, instead of calculating a product of the first and second factors, the formula (5) can be modified to obtain a sum or a weighted average of the first and second factors.

As described above, the second embodiment introduces the approximate formula (6) to calculate a probability of a sequence of n characters followed by a sequence of m characters.

Thus, the second embodiment of the present invention provides a character string dividing method for segmenting a character string into a plurality of words, comprising a step (102) of statistically calculating a joint probability of two neighboring characters (Ci−1Ci) appearing in a given document database, the joint probability (P(Ci|Ci−n - - - Ci−1)×P(Ci−1|Ci - - - Ci+m−1)) being calculated as an appearance probability of a first character string (Ci−n - - - Ci−1) appearing immediately before a second character string (Ci - - - Ci+m−1), the first character string including a former one (Ci−1) of the two neighboring characters as a tail thereof and the second character string including a latter one (Ci) of the two neighboring characters as a head thereof, and a step (103) of segmenting an objective character string into a plurality of words with reference to calculated joint probabilities so that each division point of the objective character string is present between two neighboring characters having a smaller joint probability.

It is preferable that the joint probability of two neighboring characters is calculated based on a first probability (Count(Cᵢ₋ₙ - - - Cᵢ)/Count(Cᵢ₋ₙ - - - Cᵢ₋₁)) of the first character string appearing immediately before the latter one of the two neighboring characters and also based on a second probability (Count(Cᵢ₋₁ - - - C ᵢ₊ₘ₋₁)/Count(Cᵢ - - - Cᵢ₊ₘ₋₁)) of the second character string appearing immediately after the former one of the two neighboring characters.

It is also preferable that the division point of the objective character string is determined based on a comparison between the joint probability and a threshold (δ), and the threshold is determined with reference to an average word length of resultant words.

It is also preferable that a changing point of character type is considered as a prospective division point of the objective character.

It is also preferable that a comma, parentheses and comparable symbols are considered as division points of the objective character.

Thus, the second embodiment of the present invention provides an accurate and excellent character string division method without using any dictionary, bringing large practical merits.

### Third Embodiment

A third embodiment of the present invention provides a character string dividing system comprising a word dictionary which is prepared or produced beforehand and divides or segments a character string into several words with reference to the word dictionary. The character joint probabilities used in the first and second embodiments are used in the process of dividing the character string.

First, the principle will be explained.

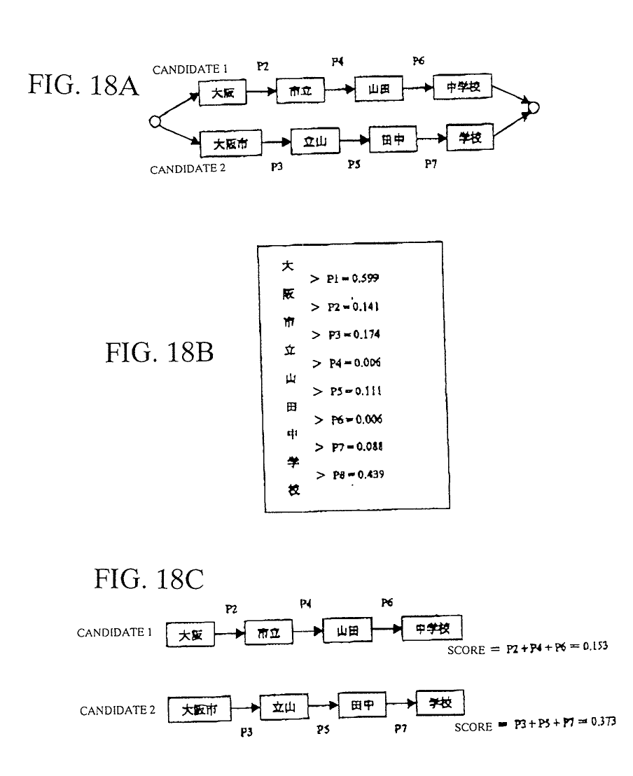

A character string “ [symbol] ” is given as an objective character string probabilities between two adjacent characters are already calculated as shown in FIG. 18B. Then, a sum of character joint probabilities is calculated as a score of each division pattern. As shown in FIG. 18C, the score of the first division pattern “ [symbol] [symbol] ” is P2+P4+P6=0.141+0.006+0.006=0.153. The score of the first division pattern “ [symbol] [symbol] ” is smaller than that of the second division pattern “ [symbol] [symbol] .” Accordingly, the first division pattern “ [symbol] [symbol] ” is selected as a correct answer.

The processing of the third embodiment of the present invention is performed in compliance with the above-described principle. The calculation procedure of the third embodiment will be explained hereinafter with reference to attached drawings.

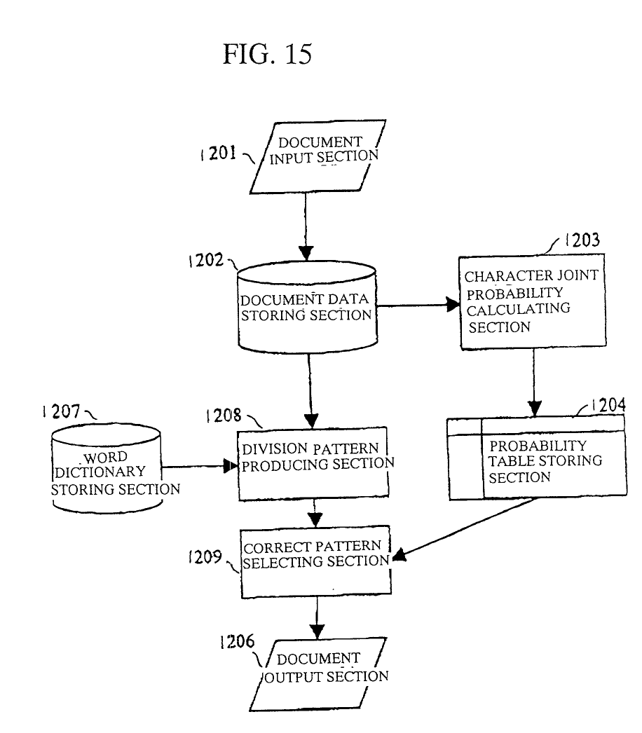

FIG. 15 is a block diagram showing an arrangement of a character string dividing system in accordance with the third embodiment of the present invention.

A document input section 1201 inputs electronic data of an objective document (or text) to be processed. A document data storing section 1202, serving as a database of document data, stores the document data received from the document input section 1201. A character joint probability calculating section 1203, connected to the document data storing section 1202, calculates a character joint probability of any two characters based on the document data stored in the document data storing section 1202. Namely, a probability of two characters existing as neighboring characters is calculated based on the document data stored in the database. A probability table storing section 1204, connected to the character joint probability calculating section 1203, stores a table of character joint probabilities calculated by the character joint probability calculating section 1203. A word dictionary storing section 1207 stores a word dictionary prepared or produced beforehand. A division pattern producing section 1208, connected to the document data storing section 1202 and to the word dictionary storing section 1207, produces a plurality of division patterns of an objective character string with reference to the information of the word dictionary storing section 1207. A correct pattern selecting section 1209, connected to the division pattern producing section 1208, selects a correct division pattern from the plurality of candidates produced from the division pattern producing section 1208 with reference to the character joint probabilities stored in the probability table storing section 1204. And, a document output section 1206, connected to the correct pattern selecting section 1209, outputs a division result of the processed document.

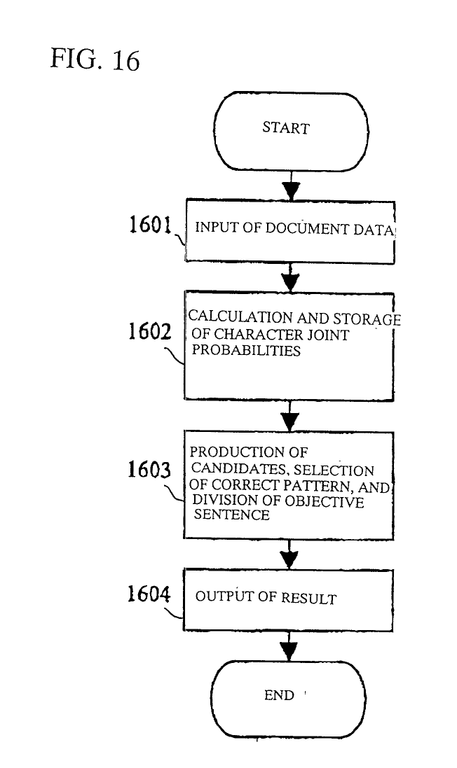

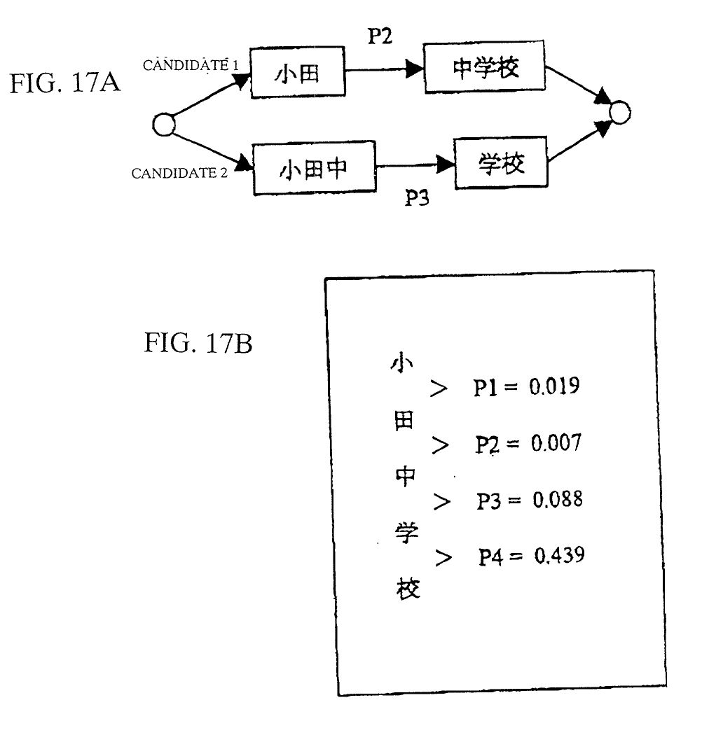

The processing procedure of the above-described character string dividing system will be explained with reference to a flowchart of FIG. 16.

Step 1601: a document data is input from the document input section 1201 and stored in the document data storing section 1202.

Step 1602: the character joint probability calculating section 1203 calculates a character joint probability of two neighboring characters involved in the document data. The calculation result is stored in the probability table storing section 1204. Regarding details of the calculation method, the above-described first or second embodiment should be referred to.

Step 1603: the division pattern producing section 1208 reads out the document data from the document data storing section 1202. The division pattern producing section 1208 produces a plurality of division patterns from the readout document data with reference to the information stored in the word dictionary storing section 1207. The correct pattern selecting section 1209 selects a correct division pattern from the plurality of candidates produced from the division pattern producing section 1208 with reference to the character joint probabilities stored in the probability table storing section 1204. The objective character string is segmented into several words according to the selected division pattern (detailed processing will be explained later).

Step 1604: the document output section 1206 outputs a division result of the processed document.

The character string dividing system of the third embodiment of the present invention, as explained above, calculates a character joint probability of two neighboring characters involved in a document to be processed. The character joint probabilities thus calculated and information of a word dictionary are used to determine division portions where the objective character string is divided into several words.

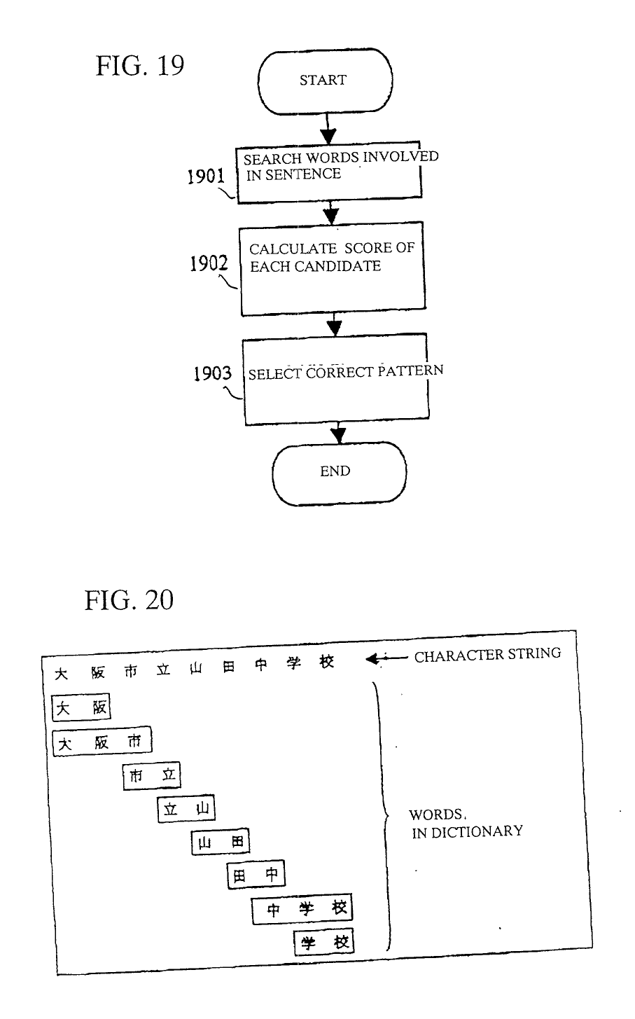

Next, details of the processing procedure in the step 1603 of FIG. 16 will be explained with reference to a flowchart of FIG. 19.

Step 1901: a character string to be divided is checked from head to tail if it contains any words stored in the word dictionary storing section 1207. For example, returning to the example of “ [symbol] [symbol] ”, this character string comprises a total of eight independent words stored in the word dictionary as shown in FIG. 20.

Step 1902: a group of words are identified as forming a division pattern if a sequence of these words agrees with the objective character string. Then, the score of each division pattern is calculated. The score is a sum of the character joint probabilities at respective division points. According to the character string “ [symbol] [symbol] ”, first and second division patterns are detected as shown in FIG. 18A. The character joint probabilities of any two neighboring characters appearing in this character string are shown in FIG. 18B. The scores of the first and second division patterns are shown in FIG. 18C.

Step 1903: a division pattern having the smallest score is selected as a correct division pattern. The score (=0.153) of the first division pattern is smaller than that (=0.373) of the second division pattern. Thus, the first division pattern is selected.

Through the above-described procedure, the character string dividing processing is accomplished. Each character joint probability is not smaller than 0. The step 1902 calculates a sum of character joint probabilities. Accordingly, when a certain character string is regarded as a single word or is further dividable into two parts, a division pattern having a smaller number of division points is always selected. For example, a character string “ [symbol] ” is further dividable into “ [symbol] ” and “ [symbol] .” In such a case, “ [symbol] ” is selected because of smaller number of division points.

According to the step 1902, the calculation of score of each division pattern is a sum of character joint probabilities. A division pattern having the smallest score is selected as a correct division pattern. This is expressed by the following formula (7).

$$arg {min}_{S} {\sum }_{i ∈ S} Pi \qquad ( 7 )$$

The calculation of score in accordance with the present invention is not limited to a sum of character joint probabilities. For example, the score can be obtained by calculating a product of character joint probabilities. This is expressed by the following formula (8).

$$arg {min}_{S} {\prod }_{i ∈ S} Pi \qquad ( 8 )$$

Furthermore, introducing logarithmic calculation will bring the same effect as calculating a product of character joint probabilities. Calculation of a product is replaceable by a sum of logarithm, as shown in the following formulas (9) and (10).

$$\begin{matrix}arg { min}_{S} log ( {\prod }_{i ∈ S} Pi ) & ( 9 ) \\ = arg {min}_{S} {\sum }_{i ∈ S} log Pi & ( 10 )\end{matrix}$$

However, the third embodiment of the present invention does not intend to limit the method of calculating the score of a division pattern. For example, in calculating the core in the step 1902, it may be preferable to introduce an algorithm of dynamic programming.

As described above, the third embodiment of the present invention obtains character joint probabilities of any two neighboring characters appearing an objective document, uses a word dictionary for identifying a plurality of division patterns of the objective character string, and selects a correct division pattern which has the smallest score with respect to character joint probabilities at prospective division points.

As described above, the third embodiment of the present invention provides a character string dividing system for segmenting a character string into a plurality of words, comprising input means (1201) for receiving a document, document data storing means (1202) serving as a document database for storing a received document, character joint probability calculating means (1203) for calculating a joint probability of two neighboring characters appearing in the document database, probability table storing means (1203) for storing a table of calculated joint probabilities, word dictionary storing means (1207) for storing a word dictionary prepared or produced beforehand, division pattern producing means (1208) for producing a plurality of candidates for a division pattern of an objective character string with reference to information of the word dictionary, correct pattern selecting means (1209) for selecting a correct division pattern from the plurality of candidates with reference to the table of character joint probabilities, and output means (1206) for outputting the selected correct division pattern as a division result of the objective character string.

Furthermore, the third embodiment of the present invention provides a character string dividing method for segmenting a character string into a plurality of words, comprising a step (1602) of statistically calculating a joint probability of two neighboring characters appearing in a given document database, a step (1602) of storing calculated joint probabilities, and a step (1603) of segmenting an objective character string into a plurality of words with reference to a word dictionary, wherein, when there are a plurality of candidates for a division pattern of the objective character string, a correct division pattern is selected from the plurality of candidates with reference to calculated joint probabilities so that each division point of the objective character string is present between two neighboring characters having a smaller joint probability.

It is preferable that a score of each candidate is calculated when there are a plurality of candidates for a division pattern of the objective character string. The score is a sum of joint probabilities at respective division points of the objective character string in accordance with a division pattern of the each candidate. And, a candidate having the smallest score is selected as the correct division pattern (refer to formula (7)).

It is also preferable that a score of each candidate is calculated when there are a plurality of candidates for a division pattern of the objective character string. The score is a product of joint probabilities at respective division points of the objective character string in accordance with a division pattern of the each candidate. And, a candidate having the smallest score is selected as the correct division pattern (refer to formula (8)).

According to the third embodiment, it is not necessary to prepare a lot of samples of correct division patterns to be produced manually beforehand. This leads to cost reduction. When a document is given, learning is automatically performed to obtain joint probabilities between any two characters appearing in the given document. Thus, it becomes possible to perform an effective learning operation suitable for the field of the given document, bringing large practical merits.

### Fourth Embodiment

A fourth embodiment of the present invention will be explained hereinafter with reference to attached drawings.

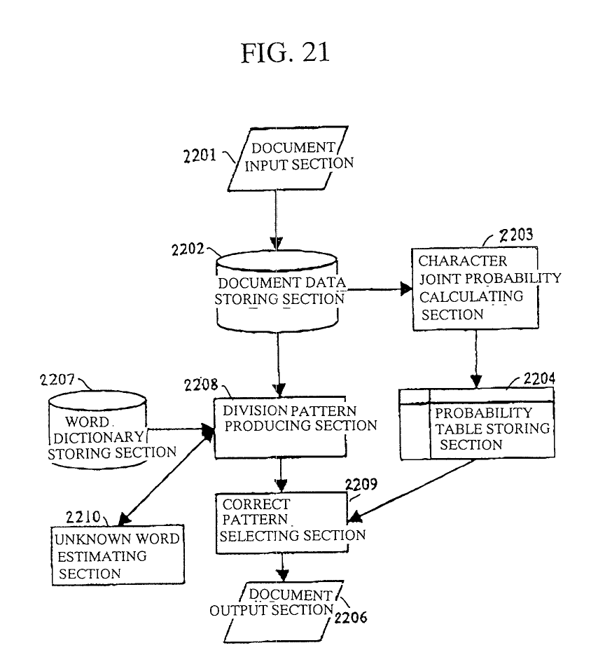

FIG. 21 is a block diagram showing an arrangement of a character string dividing system in accordance with the fourth embodiment of the present invention. A document input section 2201 inputs electronic data of an objective document (or text) to be processed. A document data storing section 2202, serving as a database of document data, stores the document data received from the document input section 2201. A character joint probability calculating section 2203, connected to the document data storing section 2202, calculates a character joint probability of any two characters based on the document data stored in the document data storing section 2202. Namely, a probability of two characters existing as neighboring characters is calculated based on the document data stored in the database. A probability table storing section 2204, connected to the character joint probability calculating section 2203, stores a table of character joint probabilities calculated by the character joint probability calculating section 2203. A word dictionary storing section 2207 stores a word dictionary prepared or produced beforehand. An unknown word estimating section 2210 estimates candidates of unknown words. A division pattern producing section 2208 is connected to each of the document data storing section 2202, the word dictionary storing section 2207, and the unknown word estimating section 2210. The division pattern producing section 2208 produces a plurality of division patterns of an objective character string readout from the document data storing section 2202 with reference to the information of the word dictionary storing section 2207 as well as unknown words estimated by the unknown word estimating section 2210. A correct pattern selecting section 2209, connected to the division pattern producing section 2208, selects a correct division pattern from the plurality of candidates produced from the division pattern producing section 2208 with reference to the character joint probabilities stored in the probability table storing section 2204. And, a document output section 2206, connected to the correct pattern selecting section 2209, outputs a division result of the processed document.

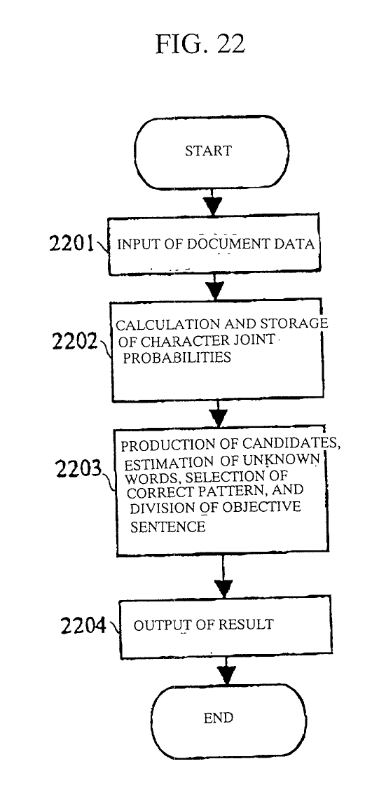

FIG. 22 is a flowchart showing processing procedure of the above-described character string dividing system in accordance with the fourth embodiment of the present invention.

Step 2201: a document data is input from the document input section 2201 and stored in the document data storing section 2202.

Step 2202: the character joint probability calculating section 2203 calculates a character joint probability of two neighboring characters involved in the document data. The calculation result is stored in the probability table storing section 2204. Regarding details of the calculation method, the above-described first or second embodiment should be referred to.

Step 2203: the division pattern producing section 2208 reads out the document data from the document data storing section 2202. The division pattern producing section 2208 produces a plurality of division patterns from the readout document data with reference to the information stored in the word dictionary storing section 2207 as well as the candidates of unknown words estimated by the unknown word estimating section 2210. The correct pattern selecting section 2209 selects a correct division pattern from the plurality of candidates produced from the division pattern producing section 2208 with reference to the character joint probabilities stored in the probability table storing section 2204. The objective character string is segmented into several words according to the selected division pattern.

Step 2204: the document output section 2206 outputs a division result of the processed document.

The character string dividing system of the fourth embodiment of the present invention, as explained above, calculates a character joint probability of two neighboring characters involved in a document to be processed. The character joint probabilities thus calculated and information of a word dictionary as well as candidate of unknown words are used to determine division portions where the objective character string is segmented into several words.

Next, details of the processing procedure in the step 2203 of FIG. 22 will be explained with reference to a flowchart of FIG. 23.

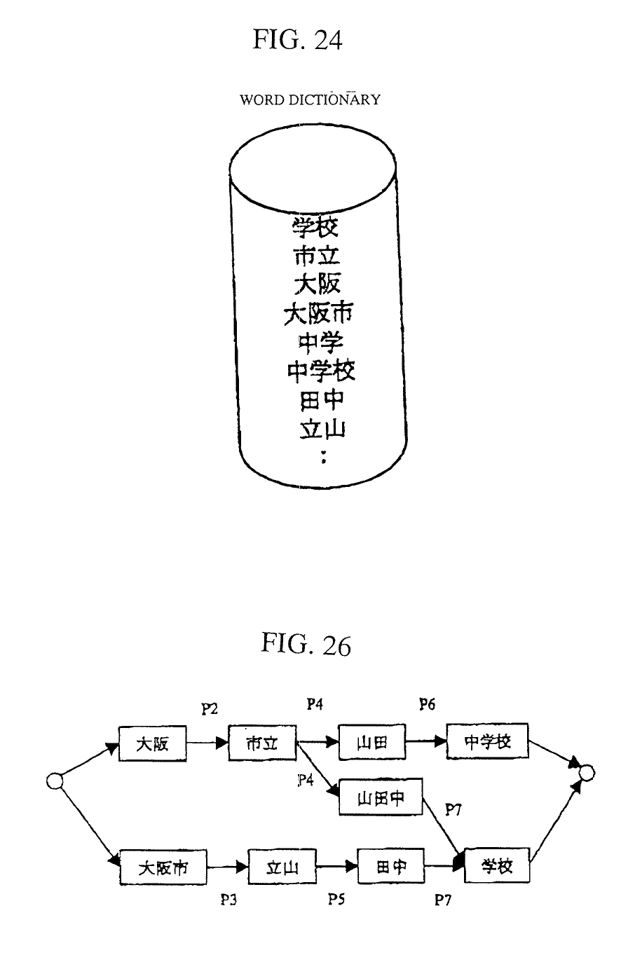

An example of “ [symbol] [symbol] ” is given as a character string to be divided. As shown in FIG. 24, it is now assumed that the word dictionary storing section 2207 stores independent words “ [symbol] [symbol] ”, “ [symbol] ”, and “ [symbol] ”, while a word “ [symbol] ” is not registered in the word dictionary storing section 2207.

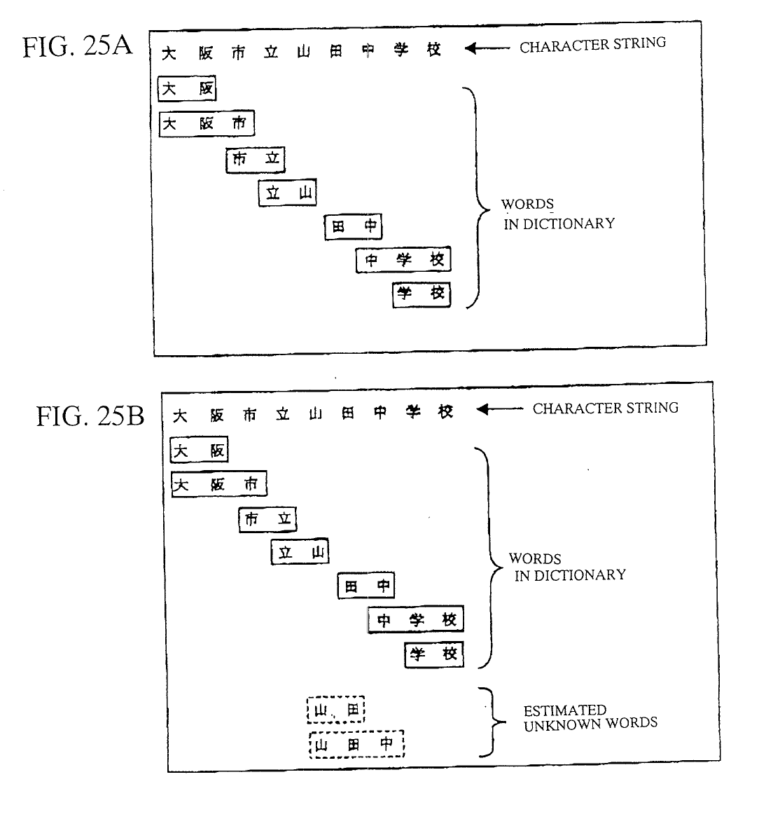

Step 2301: the objective character string is checked from head to tail if it contains any words stored in the word dictionary storing section 2207. FIG. 25A shows a total of seven words detected from the example of “ [symbol] [symbol] .” A word “ [symbol] ” is not found in this condition.

Step 2302: It is checked if any word starts from a certain character position i when a preceding word ends at a character position (i−1). When no word starting from the character position i is present, appropriate character strings are added as unknown words starting from the character position i. The character strings to be added have a character length not smaller than n and not larger than m, where n and m are positive integers. According to the example of “ [symbol] [symbol] ”, the word “ [symbol] ” ends immediately before the fifth character “ [symbol] .” However, no words starting from “ [symbol] ” are present. For example, in the case of n=2 and m=3, “ [symbol] ” and “ [symbol] ” can be added as known words as shown in FIG. 25B.

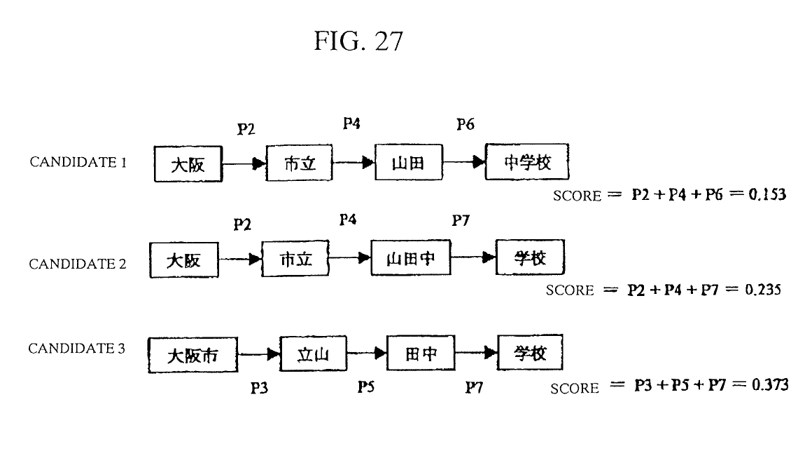

Step 2303: a group of words are identified as forming a division pattern if a sequence of these words agrees with the objective character string. FIG. 26 shows candidates of division patterns identified from the objective character string. FIG. 27 shows first, second, and third division patterns thus derived. Then, the score of each division pattern is calculated. The score is a sum of the character joint probabilities at respective division points. The character joint probabilities of any two neighboring characters appearing in this character string are shown in FIG. 18B. The scores of the first through third division patterns are shown in FIG. 27.

Step 2304: a division pattern having the smallest score is selected as a correct division pattern. The score (=0.153) of the first division pattern is smaller than those (=0.235 and 0.373) of the second and third division patterns. Thus, the first division pattern is selected.

Through the above-described procedure, the character string dividing processing is accomplished. The calculation of score is not limited to the above-described one. The calculation formula (7) is replaceable by any one of other formulas (8), (9) and (10).

As described above, the fourth embodiment of the present invention provides a character string dividing method for segmenting a character string into a plurality of words, comprising a step (2202) of statistically calculating a joint probability of two neighboring characters appearing in a given document database, a step of storing calculated joint probabilities, and a step (2203) of segmenting an objective character string into a plurality of words with reference to dictionary words and estimated unknown words, wherein, when there are a plurality of candidates for a division pattern of the objective character string, a correct division pattern is selected from the plurality of candidates with reference to calculated joint probabilities so that each division point of the objective character string is present between two neighboring characters having a smaller joint probability.

Preferably, it is checked if any word starts from a certain character position (i) when a preceding word ends at a character position (i−1) and, when no dictionary word starting from the character position (i) is present, appropriate character strings are added as unknown words starting from the character position (i), where the character strings to be added have a character length not smaller than n and not larger than m, where n and m are positive integers.

### Fifth Embodiment

According to the above-described embodiments, the score is calculated based on only joint probabilities of division points. A fifth embodiment of the present invention is different from the above-described embodiments in that it calculates the score of a division pattern by considering characteristics of a portion not divided.

In each division pattern, a character joint probability is calculated for each division point while a constant is assigned to each joint portion of characters other than the division points. The score of each division pattern is calculated by using the calculated character joint probabilities and the assigned constant values.

More specifically, it is now assumed that N represents an assembly of all character positions and S represents an assembly of character positions corresponding to division points (S⊂N). A value Qi for a character position i is determined in the following manner.

A character joint probability Pi is calculated for a character position i involved in the assembly S, while a constant Th is assigned to a character position i not involved in the assembly S (refer to formula (12)).

For each division pattern, the score is calculated by summing (or multiplying) the character joint probabilities and the assigned constant values given to respective character positions. Then, a division pattern having the smallest score is selected as a correct division pattern.

$$\begin{matrix}arg {min}_{S ⊆ N} {\sum }_{i ∈ N} Qi & ( 11 ) \\ Qi = \{ \begin{matrix}Pi , i ∈ S \\ Th , i ∉ S\end{matrix} & ( 12 ) \\ arg {min}_{S ⊆ N} ( {\sum }_{i ∈ S} Pi + {\sum }_{i ∉ S} Th ) & ( 13 )\end{matrix}$$

As an example, a character string “ [symbol] ” (new accommodation building) is given.

As shown in FIG. 28A, candidates of division patterns for this character string are as follows.

“ [symbol] ” and “ [symbol] ”

A word “ [symbol] ” involved in the second candidate is an estimated unknown word. FIG. 28B shows character joint probabilities between two characters appearing in the character string.

According to this example, the score calculated by using the formula (7) is 0.044 for the first division pattern and 0.040 for the second division pattern. In this case, the second division pattern is selected. However, the second division pattern is incorrect.

On the other hand, when the formula (11) is used, the score is calculated in the following manner.

For example, it is assumed that Th=0.03 is given. According to the first division pattern, the constant Th is assigned between characters “ [symbol] ” and “ [symbol] ” of a word “ [symbol] .” Thus, the score for the first division pattern is P1+Th+P3=0.074. According to the first division pattern, the constant Th is assigned between “ [symbol] ” and “ [symbol] ” of a word “ [symbol] ” and also between “ [symbol] ” and “ [symbol] ” of a word “ [symbol] .” The score for the second division pattern is Th+P2+Ph=0.100. As a result of comparison of the calculated scores, the first division patten is selected as a correct one.

As apparent from the foregoing, the score calculation using the formula (11) makes it possible to obtain an correct division pattern even if division patterns of an objective character string are very fine. The score calculation using the formula (7) is preferably applied to an objective character string which is coarsely divided. For example, a compound word “ [symbol] ” may be included in a dictionary. This compound word “ [symbol] ” is further dividable into two parts of “ [symbol] ” and “ [symbol] .” In general, the preciseness of division patterns should be determined considering the purpose of use of the character string dividing system. However, using the constant parameter of Th makes it possible to automatically control the preciseness of division patterns.

The formula (11) is regarded as introducing a value corresponding to a threshold into the calculation of formula (7) which calculates the score based on a sum of probabilities. Similarly, to adequately control the preciseness of division patters, a threshold can be introduced into the calculation of formula (8) which calculates the score based on a product of probabilities.

The above-described fifth embodiment can be further modified in the following manner.

Each word is assigned a distinctive constant which varies in accordance with its origin. For example, a constant U is assigned to each word stored in the word dictionary storing section 2207 and another constant V is assigned to each word stored in the unknown word estimating section 2210.

More specifically, it is now assumed that W represents an assembly of all words involved in a candidate and D represents an assembly of words stored in the word dictionary storing section 2207.

The score obtained by extension of the formula (11) is described in the following manner.

$$\begin{matrix}arg {min}_{S ⊆ N , W} ( {\sum }_{i ∈ N} Qi + {\sum }_{j ∈ W} Rj ) & ( 14 ) \\ Qi = \{ \begin{matrix}Pi , i ∈ S \\ Th , i ∉ S\end{matrix} & ( 15 ) \\ Rj = \{ \begin{matrix}U , j ∈ D \\ V , j ∈ D\end{matrix} & ( 16 ) \\ U < V & ( 17 )\end{matrix}$$

In this case, the condition U<V is for giving a priority to the words involved in the dictionary rather than the unknown words. In other words, a division pattern involving smaller number of unknown words is selected.

It is needless to say that the score can be calculated based on a product of calculated probabilities and given constants. In this case, the above formula (14) can be rewritten into a form suitable for the calculation of the product.

Introduction of the unknown word estimating section 2210, introduction of the constant Th, and introduction of score assigned to each word make it possible to realize an accurate character string dividing method according to which unknown words are estimated and selection of each unknown word is judged properly.

In the step 2303 of FIG. 23, the unknown word estimating section 2210 provides character strings each having n˜m characters as candidates for unknown words. An appropriate unknown word is selected with reference to its character joint probability. Thus, the division applied to an unknown word portion is equivalent to the division based on the character joint probabilities in the first or second embodiment. Accordingly, it becomes possible to integrate the character string division based on information of a word dictionary and the character string division based on character joint probabilities.

According to a conventional technique, estimation of unknown word is dependent on experimental knowledge such that a boundary between kanji and hiragana is a prospective division point.

According to the present invention, the step 2302 of FIG. 23 regards all of character strings satisfying given conditions as unknown words. However, a correct unknown word is properly selectable by calculating character joint probabilities. In other words, the present invention makes it possible to estimate unknown words consisting of different types of characters, e.g., a combination of kanji and hiragana.

According to the fifth embodiment of the present invention, a calculated joint probability is given to each division point of the candidate. A constant value is assigned to each point between two characters not divided. A score of each candidate is calculated based on a sum or a product of the joint probability and the constant value thus assigned. And, a candidate having the smallest score is selected as the correct division pattern (refer to the formula (13)).

Furthermore, according to the fifth embodiment of the present invention, a constant value (V) given to the unknown word is larger than a constant value (U) given to the dictionary word. A score of each candidate is calculated based on a sum (or a product) of the constant values given to the unknown word and the dictionary word in addition to a sum of calculated joint probabilities at respective division points. And, a candidate having the smallest score is selected as the correct division pattern (refer to formula (14)).

As described above, the fourth and fifth embodiments of the present invention calculate joint probabilities of two neighboring characters based on a data of an objective document to be divided beforehand. Information of a word dictionary and estimation of unknown words are used to produce candidates for division pattern of the objective character string. When there are a plurality of candidates, a division pattern having the smallest character joint probability is selected as a correct one. Regarding words not involved in a dictionary, they are regarded as unknown words. Selection of an unknown word is determined based on a probability (or a calculated score). Thus, a portion including an unknown word is divided based on a probability value. Therefore, it is not necessary to learn the knowledge for selecting a correct division pattern or to prepare a lot of correct answers for division patterns to be manually produced beforehand. This leads to cost reduction. When a document is given, learning is automatically performed to obtain character joint probabilities as the knowledge for selecting a correct division pattern. Thus, it becomes possible to perform an effective learning operation suitable for the field of the given document, bringing large practical merits. Furthermore, it is possible to separate the probability values of unknown words not included in a dictionary.

As described above, the present invention calculates a joint probability between two neighboring characters appearing in a document, and finds an appropriate division points with reference to the probabilities thus calculated.

This invention may be embodied in several forms without departing from the spirit of essential characteristics thereof. The present embodiments as described are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A character string dividing system for segmenting a character string into a plurality of words, comprising:
input means for receiving a document;
document data storing means serving as a document database for storing a received document;
character joint probability calculating means for calculating a joint probability of two neighboring characters appearing in said document database;
probability table storing means for storing a table of calculated joint probabilities;
character string dividing means for segmenting an objective character string into a plurality of words with reference to said table of calculated joint probabilities; and
output means for outputting a division result of said objective character string.

2. A character string dividing method for segmenting a character string into a plurality of words, said method comprising the steps of:
statistically calculating a joint probability of two neighboring characters appearing in a given document database; and
segmenting an objective character string into a plurality of words with reference to calculated joint probabilities so that each division point of said objective character string is present between two neighboring characters having a smaller joint probability.

3. A character string dividing method for segmenting a character string into a plurality of words, said method comprising the steps of:
statistically calculating a joint probability of two neighboring characters appearing in a given document database, said joint probability being calculated as an appearance probability of a specific character string appearing immediately before a specific character, said specific character string including a former one of said two neighboring characters as a tail thereof and said specific character being a latter one of said two neighboring characters; and
segmenting an objective character string into a plurality of words with reference to calculated joint probabilities so that each division point of said objective character string is present between two neighboring characters having a smaller joint probability.

4. A character string dividing method for segmenting a character string into a plurality of words, said method comprising the steps of:
statistically calculating a joint probability of two neighboring characters appearing in a given document database, said joint probability being calculated as an appearance probability of a first character string appearing immediately before a second character string, said first character string including a former one of said two neighboring characters as a tail thereof and said second character string including a latter one of said two neighboring characters as a head thereof; and
segmenting an objective character string into a plurality of words with reference to calculated joint probabilities so that each division point of said objective character string is present between two neighboring characters having a smaller joint probability.

5. The character string dividing method in accordance with claim 4, wherein said joint probability of two neighboring characters is calculated based on a first probability of said first character string appearing immediately before said latter one of said two neighboring characters and also based on a second probability of said second character string appearing immediately after said former one of said two neighboring characters.

6. A character string dividing method for segmenting a character string into a plurality of words, said method comprising the steps of:
statistically calculating a joint probability of two neighboring characters appearing in a given document database prepared for learning purpose; and
segmenting an objective character string into a plurality of words with reference to calculated joint probabilities so that each division point of said objective character string is present between two neighboring characters having a smaller joint probability,
wherein, when said objective character string involves a sequence of characters not involved in said document database, a joint probability of any two neighboring characters not appearing in said database is estimated based on said calculated joint probabilities for the neighboring characters stored in said document database.

7. The character string dividing method in accordance with claim 2, wherein said division point of said objective character string is determined based on a comparison between the joint probability and a threshold, and said threshold is determined with reference to an average word length of resultant words.

8. The character string dividing method in accordance with claim 2, wherein a changing point of character type is considered as a prospective division point of said objective character.

9. The character string dividing method in accordance with claim 2, wherein a comma, parentheses and comparable symbols are considered as division points of said objective character.

10. A character string dividing system for segmenting a character string into a plurality of words, comprising:
input means for receiving a document;
document data storing means serving as a document database for storing a received document;
character joint probability calculating means for calculating a joint probability of two neighboring characters appearing in said document database;
probability table storing means for storing a table of calculated joint probabilities;
word dictionary storing means for storing a word dictionary prepared or produced beforehand;
division pattern producing means for producing a plurality of candidates for a division pattern of an objective character string with reference to information of said word dictionary;
correct pattern selecting means for selecting a correct division pattern from said plurality of candidates with reference to said table of character joint probabilities; and
output means for outputting said selected correct division pattern as a division result of said objective character string.

11. A character string dividing method for segmenting a character string into a plurality of words, said method comprising the steps of:
statistically calculating a joint probability of two neighboring characters appearing in a given document database;
storing calculated joint probabilities; and
segmenting an objective character string into a plurality of words with reference to a word dictionary,
wherein, when there are a plurality of candidates for a division pattern of said objective character string, a correct division pattern is selected from said plurality of candidates with reference to calculated joint probabilities so that each division point of said objective character string is present between two neighboring characters having a smaller joint probability.

12. The character string dividing method in accordance with claim 11, wherein
a score of each candidate is calculated when there are a plurality of candidates for a division pattern of said objective character string,
said score is a sum of joint probabilities at respective division points of said objective character string in accordance with a division pattern of said each candidate, and
a candidate having the smallest score is selected as said correct division pattern.

13. The character string dividing method in accordance with claim 11, wherein
a score of each candidate is calculated when there are a plurality of candidates for a division pattern of said objective character string,
said score is a product of joint probabilities at respective division points of said objective character string in accordance with a division pattern of said each candidate, and
a candidate having the smallest score is selected as said correct division pattern.

14. The character string dividing method in accordance with claim 11, wherein
a calculated joint probability is given to each division point of said candidate;
a constant value is assigned to each point between two characters not divided;
a score of each candidate is calculated based on a sum of said joint probability and said constant value thus assigned; and
a candidate having the smallest score is selected as said correct division pattern.

15. The character string dividing method in accordance with claim 11, wherein
a calculated joint probability is given to each division point of said candidate;
a constant value is assigned to each point between two characters not divided;
a score of each candidate is calculated based on a product of said joint probability and said constant value thus assigned; and
a candidate having the smallest score is selected as said correct division pattern.

16. A character string dividing system for segmenting a character string into a plurality of words, comprising:
input means for receiving a document;
document data storing means serving as a document database for storing a received document;
character joint probability calculating means for calculating a joint probability of two neighboring characters appearing in said document database;
probability table storing means for storing a table of calculated joint probabilities;
word dictionary storing means for storing a word dictionary prepared or produced beforehand;
unknown word estimating means for estimating unknown words not registered in said word dictionary;
division pattern producing means for producing a plurality of candidates for a division pattern of an objective character string with reference to information of said word dictionary and said estimated unknown words;
correct pattern selecting means for selecting a correct division pattern from said plurality of candidates with reference to said table of character joint probabilities; and
output means for outputting said selected correct division pattern as a division result of said objective character string.

17. A character string dividing method for segmenting a character string into a plurality of words, said method comprising the steps of:
statistically calculating a joint probability of two neighboring characters appearing in a given document database;
storing calculated joint probabilities; and
segmenting an objective character string into a plurality of words with reference to dictionary words and estimated unknown words,
wherein, when there are a plurality of candidates for a division pattern of said objective character string, a correct division pattern is selected from said plurality of candidates with reference to calculated joint probabilities so that each division point of said objective character string is present between two neighboring characters having a smaller joint probability.

18. The character string dividing method in accordance with claim 17, wherein it is checked if any word starts from a certain character position (i) when a preceding word ends at a character position (i−1) and, when no dictionary word starting from said character position (i) is present, appropriate character strings are added as unknown words starting from said character position (i), where said character strings to be added have a character length not smaller than n and not larger than m, where n and m are positive integers.

19. The character string dividing method in accordance with claim 17, wherein
a constant value given to said unknown word is larger than a constant value given to said dictionary word,
a score of each candidate is calculated based on a sum of said constant values given to said unknown word and said dictionary word in addition to a sum of calculated joint probabilities at respective division points, and
a candidate having the smallest score is selected as said correct division pattern.

20. The character string dividing method in accordance with claim 17, wherein
a constant value given to said unknown word is larger than a constant value given to said dictionary word,
a score of each candidate is calculated based on a product of said constant values given to said unknown word and said dictionary word in addition to a product of calculated joint probabilities at respective division points, and
a candidate having the smallest score is selected as said correct division pattern.
